(19) United States
(12) Patent Application Publication
(10) Pub. No.: US 2009/0055005 A1
(43) Pub. Date: Feb. 26, 2009

(54) Audio Processor

(75) Inventors: Gedalia Oxman, Tel-Aviv (IL); Hila Madar, Haifa (IL); Amir Morad, Tel-Aviv (IL); Leonid Yavits, Herzlia (IL); Michael Khrapkovsky, Herzlia (IL); David M. Castiel, Kfar-Saba (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 11/892,494

(22) Filed: Aug. 23, 2007

(51) Int. Cl. G06F 17/00; G06F 15/00

(52) U.S. Cl. 700/94; 712/36

(57) ABSTRACT

Apparatus for processing audio signal streams including a plurality of audio signal inputs, an audio signal output, and a plurality of audio signal processing units, wherein the audio signal input, the audio signal output, and the plurality of audio signal processing units are connected to and controlled by a Micro Controller Unit (MCU), and wherein the audio signal processing units are configured to process more than one audio signal stream at the same time. Related apparatus and methods are also described.

### FIELD OF THE INVENTION

The present invention relates to audio processor architecture, and in particular to System on a Chip (SoC) devices which reside in digital communication systems.

### BACKGROUND OF THE INVENTION

Set top boxes for cable, for satellite, for IPTV (Internet Protocol TV), for DTVs (Digital TVs), DVDs, camcorders, and home gateways, are configured to receive and transmit store and play-back multiplexed video, audio, and data media streams. The devices mentioned above, collectively termed herein set top boxes (STBs), are typically used to receive analog and digital media streams, which include compressed and uncompressed video, audio, still image, and data channels. The streams are transmitted through cable, satellite, terrestrial, and IPTV links, or through a home network. The devices demodulate, decrypt, de-multiplex and decode the transmitted streams, and, by way of a non-limiting, typical example, provide output for television display. Additionally, the devices may store the streams in storage devices, such as, by way of a non-limiting example, a hard disk. In addition, the devices may compress, encrypt and multiplex uncompressed and/or compressed audio, video and data packets, and transmit such a multiplexed stream to an additional storage device, to another STB, to a home network, and the like.

Some digital television sets include electronic components similar to the STBs, and are able to perform tasks performed by a basic set-top box, such as de-multiplexing, decryption and decoding of one or two Audio/Video channels of a multiplexed compressed stream.

The digital television sets and STBs may receive a multi-channel transport/program stream containing video, audio and data packets, encoded in accordance with a certain encoding standard such as, by way of a non-limiting example, MPEG-2 or MPEG-4 AVC standard. The data packets may represent e-mail, graphics, gaming, an Electronic Program Guide, Internet information, etc.

A program stream protocol and a transport stream protocol are specified in MPEG-2 Part 1, Systems (ISO/IEC standard 13818-1). Program streams and transport streams enable multiplexing and synchronization of digital video and audio streams. Transport streams offer methods for error correction, used for transmission over unreliable media. The transport stream protocol is used in broadcast applications such as DVB (Digital Video Broadcasting) and ATSC (Advanced Television Systems Committee). The program stream is designed for more reliable media such as DVD and hard-disks.

In these applications, analog and digital audio signals are processed. Processing methods and application areas include storage, level compression, data compression, transmission, and enhancement such as equalization, filtering, noise cancellation, echo or reverb removal or addition, and so on.

### SUMMARY OF THE INVENTION

The present invention seeks to provide an improved apparatus and methods for audio processing of multiple audio streams.

According to one aspect of the present invention there is provided apparatus for processing audio signal streams including a plurality of audio signal inputs, an audio signal output, a Micro Controller Unit (MCU), and a plurality of audio signal processing units, and wherein the audio signal input, the audio signal output, and the plurality of audio signal processing units are connected to and programmably controlled by the MCU, and wherein the audio signal processing units are configured to process more than one audio signal stream at the same time.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified block diagram of an audio processor constructed and operative in accordance with a preferred embodiment of the present invention.

FIG. 1B is a more detailed simplified block diagram of the audio processor of FIG. 1A.

FIG. 2 is a simplified functional flow diagram of operations in a FIR accelerator register array in the audio processor of FIG. 1A.

FIG. 3 is a simplified functional block diagram of operations of the FIR Accelerator and FIFOs of the audio processor of FIG. 1A.

FIG. 4 is a simplified functional block diagram of the FIR accelerator of the audio processor of FIG. 1A.

FIG. 5 is a simplified flowchart illustration of a basic calculation cell in the FIR accelerator of the audio processor of FIG. 1A.

FIG. 6 is a simplified flowchart illustration of a read state machine in the FIR accelerator of the audio processor of FIG. 1A.

FIG. 7 is a simplified flowchart illustration of a save-result state machine in the FIR accelerator of the audio processor of FIG. 1A.

FIG. 8 is a simplified flowchart illustration of a write state machine in the FIR accelerator of the audio processor of FIG. 1A.

FIG. 9 is a first simplified functional diagram of calculation steps of the FIR accelerator of the audio processor of FIG. 1A.

FIG. 10 is a second simplified functional diagram of calculation steps of the FIR accelerator of the audio processor of FIG. 1A.

FIG. 11 is a simplified functional diagram of an IIR accelerator in the audio processor of FIG. 1A.

FIG. 12 is a simplified flow chart of a logarithmic accelerator of the audio processor of FIG. 1A.

FIG. 13 is a simplified functional diagram of an embodiment of a polynomial accelerator in the audio processor of FIG. 1A.

FIG. 14 is a simplified flow chart of an Add-dB accelerator of the audio processor of FIG. 1A.

FIG. 15 is a simplified functional diagram of the Micro Controller Unit (MCU) of the audio processor of FIG. 1A.

FIG. 16 is a simplified functional diagram of an alternative embodiment of an MCU in the audio processor of FIG. 1A.

FIG. 17 is a simplified flowchart of a method of processing media streams by the audio processor of FIG. 1A.

FIG. 18 is a simplified block diagram of a non-limiting example of a practical use for the audio processor of FIG. 1A.

### DESCRIPTION OF THE PREFERRED EMBODIMENTS

Embodiments of the present invention comprise an improved apparatus and methods for audio processing of multiple audio streams.

The term “data stream” in all its forms is used throughout the present specification and claims interchangeably with the term “audio stream” and its corresponding forms.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

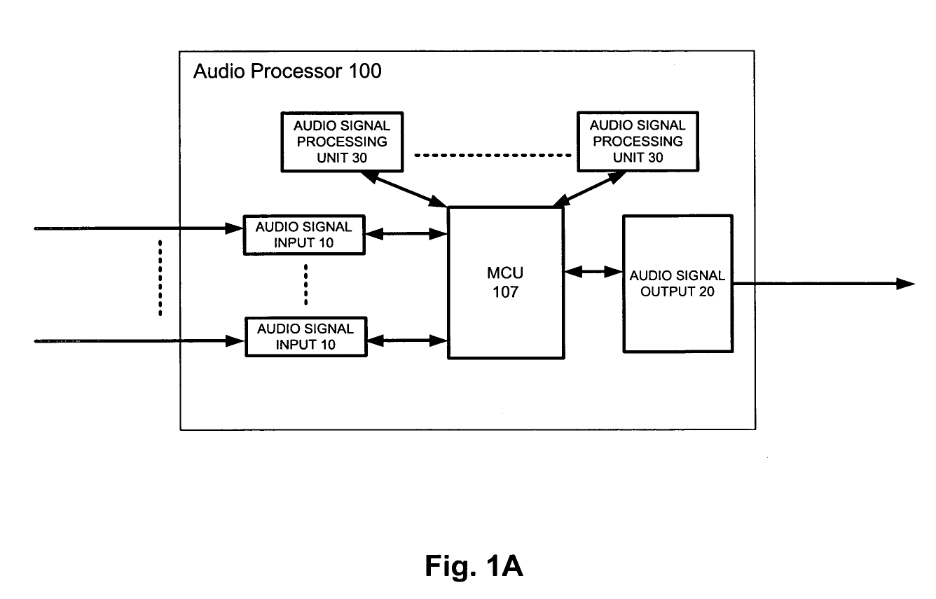

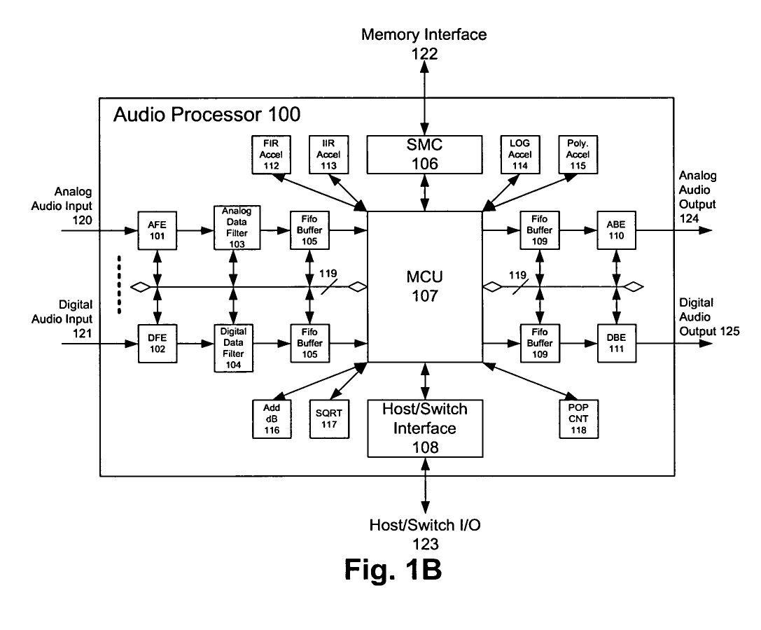

Reference is now made to FIG. 1A, which is a simplified block diagram of an audio processor constructed and operative in accordance with a preferred embodiment of the present invention.

An audio processor 100 comprises several audio signal input units 10, which are connected to a Micro Controller Unit (MCU) 107. The MCU 107 is connected to several audio signal processing units 30, and to at least one audio signal output unit 20.

The MCU 107 controls operation of the audio signal input units 10, the audio signal processing units 30, and the audio signal output unit 20. The MCU 107 can read status of the audio signal input units 10, the audio signal processing units 30, and the audio signal output unit 20, and can instruct the audio signal input units 10, the audio signal processing units 30, and the audio signal output unit 20 to perform input, processing, and output operations.

The MCU 107, being a Micro Controller Unit, is typically programmed to perform the controlling based, at least in part, on inputs from the audio signal input units 10, the audio signal processing units 30, and the audio signal output unit 20. The audio signal input units 10, the audio signal processing units 30, and the audio signal output unit 20 receive instructions from the MCU 107, and are configured to perform their tasks in parallel, so that more than one audio stream can be processed at a time.

By way of a non-limiting example, two audio streams are input into two audio signal input units 10, the two audio streams are suitably buffered, processed, and merged by the audio signal processing units 30 working in parallel, and a merged audio stream is output by the audio signal output unit 20.

A more detailed description of the audio processor 100 of FIG. 1A and its operation is provided below, with reference to FIG. 1B.

Reference is now made to FIG. 1B which is a more detailed simplified block diagram of the audio processor of FIG. 1A.

The audio processor 100 comprises: one or more analog audio inputs 120, one or more digital audio inputs 121, one or more AFEs (Analog Front Ends) 101, one or more DFEs (Digital Front Ends) 102, one or more analog data filters 103, one or more digital data filters 104, one or more input FIFO buffers 105, a memory interface 122, a Secured Memory Controller (SMC) 106, a Micro Controller Unit (MCU) 107, a Host/Switch interface 108, a Host/Switch input/output (I/O) 123, one or more output FIFO buffers 109, one or more ABEs (Analog Back Ends) 110, one or more DBEs (Digital Back Ends) 111, one or more analog audio outputs 124, one or more digital audio outputs 125, one or more Finite Impulse Response (FIR) accelerators 112, one or more Infinite Impulse Response (IIR) accelerators 113, one or more logarithmic accelerators 114, one or more polynomial accelerators 115, one or more add-dB accelerators 116, one or more SQRT accelerators 117, one or more population count accelerators 118, and a control bus 119.

The components and interconnections comprised in the audio processor 100 will now be described.

In a preferred embodiment of the present invention, the audio processor 100 receives several audio streams in parallel, through the analog audio inputs 120, the digital audio inputs 121, the memory interface 122, and the Host/Switch I/O 123.

For analog audio streams, a copy protection scheme such as Verance audio watermarking may be implemented. It should be noted that any other copy protection scheme that can prevent unauthorized access or illegitimate use may also be implemented, protecting both analog and digital, compressed and uncompressed, audio streams. The audio processor 100 deciphers such information from input, and embeds such information on output, accordingly.

Preferably, compressed audio signals are decompressed by the multi-standard audio processor 100. Various decompression algorithms, defined according to various protocols, such as MPEG1, AC-3, AAC, MP3 and others, may be used during the decompression process. The audio processor 100 also blends multiple uncompressed audio channels together, in accordance with control commands, which may be provided via the Host/Switch interface 108.

In a preferred embodiment of the present invention, the audio processor 100 may be used as an “audio ENDEC processor” as described in U.S. patent application Ser. No. 11/603,199 of Morad et al, the disclosure of which, as well as the disclosures of all references mentioned in the U.S. patent application Ser. No. 11/603,199 of Morad et al, are hereby incorporated herein by reference.

### The Analog Front End 101

The Analog Front End (AFE) 101 receives analog audio signals from the analog audio inputs 120. In a preferred embodiment of the present invention, the AFE 101 comprises an array of audio ADCs (Analog to Digital Converters), which convert multi-channel analog audio to digital form. The digital audio signal output of the AFE 101 is transferred to the digital data filter 104.

Persons skilled in the art will appreciate that such ADCs should be of high quality, low noise, with sufficient sampling rate and resolution to support high quality audio, such as 48 KHz, 96 KHz, and 192 KHz, with a resolution of at least 24 bits.

In a preferred embodiment of the present invention, the AFE 101 is programmed and monitored by the MCU 107, through the control bus 119.

In another preferred embodiment of the present invention, the AFE 101 is in form of a socket, and connects to an audio visual pre-processor such as described in U.S. patent application Ser. No. 11/603,199 of Morad et al.

### The Digital Front End 102

The Digital Front End (DFE) 102 receives digital audio signals from the digital audio inputs 121. In a preferred embodiment of the present invention, the DFE 102 comprises an array of physical interfaces, such as I2S, S/PDIF-Optical, and S/PDIF-RF and the like. The physical interfaces accept multi-channel digital compressed and uncompressed audio samples and transfer them to the digital data filter 104.

In a preferred embodiment of the present invention, each I2S input interface may independently:
Sample incoming data at a positive edge or a negative edge of an input clock.
Be provided input in MSB-first or LSB-first format.
Accept different sample word lengths. Bits are collected until a word of the specified word length is produced, then the word is stored in the FIFO 105.
Acquire a left channel or a right channel first.
Accept different left and right delay, that is, the delay in bits between a bit in which a left_right₁₃ clk changes and a bit in which a data word starts.
Adjust amplification and attenuation for each data word, that is, adjust independent amplitude and attenuation for each channel, left and right.
Adjust a range of maximum and minimum clipping value for each data word, that is, independently clip the left channel and the right channel.
Independently mute each of the left and the right channel.
Adjust a frame size. At each frame start a timestamp is collected in a dedicated register which the MCU 107 can access. The register is a double buffer register, so that the MCU 107 has enough time to read it before it is overwritten. In addition a special register which counts the number of frames is incremented.
Change a status of a timestamp flag whenever a timestamp is sampled, so that together with another register, termed a frame_counter, the MCU 107 knows when a frame is ready.
Choose which input clock the I2S input should use.
Choose which clock the I2S input should use for timestamp sampling, from among a system clock, an external clock, and the like.

In a preferred embodiment of the present invention, each SPDIF input interface can be programmed independently to:
Accept different sample word lengths. Bits are collected until a word of the specified word length is produced, then the word is stored in the FIFO 105.
Adjust amplification and attenuation for each data word, that is, adjust independent amplitude and attenuation for each channel, left and right.
Adjust a range of maximum and minimum clipping value for each data word, that is, independently clip the left channel and the right channel.
Independently mute each of the left and the right channel.
Adjust a frame size. At each frame start a timestamp is collected in a dedicated register which the MCU 107 can access. The register is a double buffer register, so that the MCU 107 has enough time to read it before it is overwritten. In addition a special register which counts the number of frames is incremented.
Change a status of a timestamp flag whenever a timestamp is sampled, so that together with another register, termed a frame_counter, the MCU 107 knows when a frame is ready.
Select a coding range word to be 20 or 24 bits long.
Choose which input clock the SPDIF interface should use.
Indicate a strobe/packet error using an associated register, so that the MCU 107 can identify if an error has occurred.
Collect channel status data into a table the can be read by the MCU 107.
Automatically detect and handle a non linear PCM encoded audio transmission in accordance with the IEC 61937 standard.

In a preferred embodiment of the present invention, the AFE 102 can be programmed and monitored by the MCU 107, through the control bus 119.

In another preferred embodiment of the present invention, the DFE 102 is in form of a socket, and connects to an audio visual pre-processor such as described in U.S. patent application Ser. No. 11/603,199 of Morad et al.

### The Analog Data Filter 103

The analog data filter 103 preferably comprises an array of filters for pre-processing and filtering of received audio signals. The pre-processing includes audio signal processing such as volume control, loudness, equalizer, balance, treble-control, channel down-mix, up-mix, pseudo-stereo, and so on.

The analog data filter 103 preferably includes a BTSC decoder to support decoding standards such as, for example, NTSC and PAL. Additional signal processing processes, such as linear and nonlinear noise reduction and audio sample-rate conversion, can be employed as well. The analog data filter 103 preferably comprises analysis capabilities, psycho-acoustic modeling, and so on. The analog data filter 103 formats audio samples and feed the audio samples to the FIFO buffer 105.

In a preferred embodiment of the present invention, the analog data filter 103 can be programmed and monitored by the MCU 107, through the control bus 119.

### The Digital Data Filter 104

The digital data filter 104 preferably has an array of filters for allowing pre-processing and filtering of received digital audio signals. The pre-processing includes digital audio signal processing such as volume control, loudness, equalizer, balance, treble-control, channel down-mix, up-mix, pseudo-stereo, and so on. The digital data filter 103 preferably includes a BTSC decoder to support decoding standards such as, for example, NTSC and PAL.

Additional signal processing processes, such as linear and nonlinear noise reduction and audio sample-rate conversion, can be employed as well. The digital data filter 104 preferably has analysis capabilities, psycho-acoustics modeling, and so on. The digital data filter 104 formats audio samples and feeds the audio samples to the FIFO buffer 105. A non-limiting example of formatting is a removal of SPDIF headers, identification of a packet start and a packet end, sign-extension of 8 bit and 16 bit audio signals to 24 bits, and so on.

As specified in the SPDIF standard, each SPDIF block is composed of 192 frames, each frame consists of 2 sub-frames, and each sub-frame carries its own flags. For every sub-frame, a channel status bit provides information related to an audio channel which is carried in the sub-frame. Channel status information is organized in a 192-bit block.

For both I2S and SPDIF, the digital data filter 104 samples incoming audio bits into a register whenever a bit clock signal rises or falls, as configured in the digital data filter 104. The number of sampled bits is counted, and when an entire audio sample, up to 24 bits, has been collected, the audio sample is processed before passing the audio sample for storage in the input FIFO buffer 105.

When handling the SPDIF interface, a parity bit is also verified and replaced by a parity checksum, thus saving time for later processing by the MCU 107. The rest of the SPDIF flags and headers are passed as is. In addition, channel status bits are collected in a table which can be accessed through the control bus 119.

In both the SPDIF interface and the I2S interface, the samples are sign extended, amplified or attenuated, clipped to a configured number of bits, and left aligned in a dedicated storage register (not shown) comprised within the digital data filter 104. The processed sample is then stored in the input FIFO buffer 105. It is to be appreciated that all the input interfaces are connected to the input FIFO buffer 105 via an arbiter.

In the SPDIF interface, when a non-linear PCM encoded audio bit-stream is detected, the data filter 104 extracts data from the input bits, and stores the data as is in the input FIFO buffer 105.

In an alternative preferred embodiment of the present invention the I2S interface and the SPDIF interface have a bypass mode.

In the I2S interface, the bypass mode assigns a lrclk (Left Right Clock) signal to bit 28 of the sampled data, stores the sampled data in the input FIFO buffer 105, and no other subsequent processing is made to the sampled data.

In the SPDIF interface there are a few possible bypass modes: bypass all, bypass valid 0, and bypass valid 1.

In bypass all mode no processing is performed on the incoming sample. The incoming sample, flags, and preamble are stored in the input FIFO buffer 105.

In bypass valid 0 mode the parity bit is verified and replaced by the parity checksum. If a valid flag received with the sample is 0, no further processing is performed on the sample. If the valid flag received with the sample is 1, the sample goes through the same process described above, after which the sample is stored in the input FIFO buffer 105.

In bypass valid 1 mode the parity bit is verified and replaced by the parity checksum. If the valid flag received with the sample is 1, no further processing is performed on the sample. If the valid flag received with the sample is 0, the sample goes through the same process described above, after which the sample is stored in the input FIFO buffer 105.

In another preferred embodiment of the present invention, the digital data filter 104 may receive digital audio samples directly from the Secure Memory Controller (SMC) 106, or from the Host/Switch interface 108, in form of uncompressed raw audio, or packetized audio, such as, by way of example, SPDIF packets. The digital data filter 104 processes the digital audio samples in the manner described above. The above mode of operation allows processing of media streams from a plurality of input interfaces. As a non-limiting example, the audio processor 100 may transcode an audio stream from one encoding standard and bit-rate to another encoding standard and bit-rate, as follows:

The MCU 107 decodes, using a set of decoding standards and parameters, a stream acquired from the Host/Switch interface 108, transfers the decoded audio samples to the SMC 106 using external storage as a temporary buffer, fetches the decoded audio samples via the SMC 106 into the digital data filter 104, and subsequently encodes, preferably using another set of encoding standards and parameters, and provides the encoded audio samples to the Host/Switch interface 108.

In a preferred embodiment of the present invention, the digital data filter 104 may be programmed and monitored by the MCU 107, through the control bus 119.

### The Input FIFO Buffer 105

The input FIFO buffer 105 stores pre-processed/filtered audio packets, and results from the IIR accelerator 113 and the FIR accelerator 112, into a First In First Out (FIFO) memory. FIFO describes a principle of a queue, or first-come, first-served (FCFS) behavior: data which comes in first is handled first, and data which comes in next waits until the first is handled, and so on. The MCU 107 reads stored packets from the input FIFO buffer 105, and processes the stored packets in an order in which the stored packets were received.

In a preferred embodiment of the present invention, each input FIFO buffer 105 can be programmed independently to:
Divide into partitions, one for each input channel, comprising result samples from the FIR accelerator 112 and the IIR accelerators 113,. Each input FIFO buffer 105 comprises dedicated registers for storing a base_address, an end_address, and a step_address, which is the number of addresses to skip after writing one word. A first, base, address of an input channel partition inside the input FIFO buffer 105 is stored in base_address. A last address of the input channel partition is stored in end_address. A number of addresses that should be skipped between 2 consecutive write commands to the same channel partition is stored in step_address. For example, if the input channel needs a 16 address partition, and no skipping between 2 consecutive write commands, the input channel can be mapped in addresses 0-15 of the input FIFO 105, that is, base_address=0, end_address=15, and step_address=1, so that no addresses are skipped between write commands. It is to be appreciated that the step_address helps when the MCU 107 requires words from different channels to be interleaved in the memory, for saving microcode operations.
Assign a value of the base_address to a write address or to a read address when the write address or the read address reaches the end_address.
Write each data word which is collected from an input channel into the input FIFO buffer 105 in a current address which a write pointer points to.

The input FIFO buffer 105 enables the following features:

If input is from a SPDIF channel, checking the parity bit and replacing the parity bit by a bit indicating whether there was a parity error or not. The checking and replacing saves microcode operations for checking the parity. It is to be appreciated that each input interface has its own enable bit, which can be enabled/disabled by microcode, enabling and disabling the above checking and replacing.

When the IIR accelerator 113 or the FIR accelerator 112 are used, the FIFO 105 is used for writing results back to a data cache, by using the same memory and existing interface of the pre-processed/filtered audio packets. Re-use of the same memory and interface saves having an additional memory bank, which would have otherwise be required. The MCU 107 microcode programs the IIR accelerator 113 and the FIR accelerator 112 to use the input FIFO buffer 105 for storing the results.

When a number of words in an input FIFO buffer 105 partition exceeds an almost_full threshold, an automatic DMA process starts. The process can also be activated manually by microcode. The process copies words to one of two data caches, numbered 0 or 1, according to a pre-configured register. The almost_full threshold is configured in a dedicated register. For example, if the input FIFO buffer 105 partition consists of 16 addresses, the almost_full threshold will normally be lower than 16, which would indicate that the partition is already full, but higher than 8, which would indicate that only half of the partition is full.

The words are copied until the number of words in the partition is lower than an almost_empty threshold. The almost_empty threshold is configured in a dedicated register. For example, if the partition consists of 16 addresses, the threshold will normally be higher than 0, which would indicate that the partition is already empty, but lower than 8, which would indicate that only half of the partition is empty.

A register named word_count is used to count a number of words stored in each partition. When a word is written to a certain FIFO partition, the word_count of that partition is increased, and if a word is read, the word_count is decreased

Each partition has a dedicated reset register that can be configured by the MCU 107. By writing to the reset register, the read and write address pointers are set to base_address, and the counter word_count is set to 0, thus resetting the dedicated partition register to an initial state.

Each data cache is also programmed to be divided into partitions, preferably 2 partitions for each input channel. Each partition is of a size of a single audio frame, so as to enable a double buffer per channel. The data cache may also be dynamically programmed to support multiple partitions for the FIR accelerator 112 and the IIR accelerators 113 input samples, and for the FIR accelerator 112 coefficients.

The input FIFO buffer 105 also preferably comprises dedicated registers for storing the base_address, end_address and step address. A first data cache address of the channel partition is stored in the base_address register. A last data cache address of the channel partition is stored in the end_address register. The number of addresses that should be skipped between 2 consecutive write commands to the same channel partition are concatenated and stored in each of the step_address registers. For example, if a channel requires a 512 address partition, and there is no skipping between 2 consecutive write commands, the channel is mapped in addresses 0-511 of the data cache, that is, base_address=0, end_address=511, and step_address=1, so that no addresses will be skipped between write commands.

Each partition has a dedicated register which enables flushing the entire data residing in the input FIFO buffer 105 to the data cache. The flushing ignores the almost_empty register, and reads the data from the input FIFO buffer 105 until word_count is 0, and transfers the data to the cache.

When an entire frame is ready in the data cache, a timestamp is sampled, a timestamp flag changes status, and microcode identifies this situation by reading the timestamp flag.

When the IIR accelerator 113 or the FIR accelerator 112 have completed their processing, they automatically flush results residing in the input FIFO buffer 105 to the data cache, and signal the microcode that the results have been flushed. The signaling is done by modifying a dedicated register polled by the MCU 107, or by an issuing an interrupt to the MCU 107.

In a preferred embodiment of the present invention, the input FIFO buffer 105 may be programmed and monitored by the MCU 107, through the control bus 119.

### The Secure Memory Controller (SMC) 106

The SMC 106 is responsible for secured communication with an external memory device or devices. In a preferred embodiment of the present invention, the SMC 106 comprises an entire memory controller and an associated physical layer required to interface an external high speed memory, which is connected to the memory interface 122. The SMC 106 interfaces directly to memory devices such as SRAM, DDR memory, flash memory, and so on, via the memory interface 122.

In a preferred embodiment of the invention, the SMC Controller 106 may be programmed and monitored by the MCU 107.

In another preferred embodiment of the present invention, the SCD Controller 106 is in form of a socket of, and connects to, a secure memory controller in such as described in U.S. patent application Ser. No. 11/603,199 of Morad et al.

### The MCU 107

The MCU 107 is a micro-controller, comprising a pipelined controller, one or more arithmetic-logic units, one or more register files, one or more instruction and data memories, and additional components. The instruction set of the MCU 107 is designed to support encoding, decoding, and parsing of multi-stream audio, video, and data signals.

### The Host/Switch Interface 108

The Host/Switch interface 108 preferably provides a secure connection between the MCU 107 and external devices.

The external devices include, by way of a non-limiting example, an external hard-disk, an external DVD, a high density (HD)-DVD, a Blu-Ray disk, electronic appliances, and so on.

The Host/Switch interface 108 also preferably supports connections to a home networking system, such as, by way of non-limiting examples, Multimedia over Coax Alliance (MOCA) connections, phone lines, power lines, and so on.

The Host/Switch interface 108 supports glueless connectivity to a variety of industry standard Host/Switch I/O 123. The industry standard Host/Switch I/O 123 includes, by way of a non-limiting example, a Universal Serial Bus (USB), a peripheral component interconnect (PCI) bus, a PCI-express bus, an IEEE-1394 Firewire bus, an Ethernet bus, a Giga-Ethernet (MII, GMII) bus, an advanced technology attachment (ATA), a serial ATA (SATA), an integrated drive electronics (IDE), and so on.

The Host/Switch interface 108 also preferably supports a number of low speed peripheral interfaces such as universal asynchronous receiver/transmitter (UART), Integrated-Integrated Circuit (I2C), IrDA, Infra Red (IR), SPI/SSI, Smartcard, modem, and so on.

In a preferred embodiment of the present invention, the Host/Switch interface 108 may be programmed and monitored by the MCU 107.

In another preferred embodiment of the present invention, the Host/Switch interface 108 is in form of a socket of, and connects to, a central switch as described in U.S. patent application Ser. No. 11/603,199 of Morad et al.

### The Output FIFO Buffer 109

The output FIFO buffer 109 serves for storage of audio samples from the IIR accelerator 113 and the FIR accelerator 112; filter coefficients of the FIR accelerator 112; compressed audio data, in case of non linear PCM SPDIF; and uncompressed multi-channel audio samples, with embedded copy protection signals, which are generated and formed into packets by the MCU 107. The output FIFO buffer 109 can be “slaved” to the MCU 107, and can also independently access output samples, input samples in the FIR accelerator 112 and the IIR accelerator 113, filter coefficients of the FIR accelerator 112, and compressed audio data directly from cache memory of the MCU 107.

The output FIFO buffer 109 comprises data caches, similarly to the data caches described above with reference to the input FIFO buffer 105. The data caches, single or dual according to a pre-configured register, within the output FIFO buffer 109, have 2 partitions for each output channel, each partition the size of an entire audio frame. The MCU 107 has dedicated registers storing a base_address, an end_address and one or more step_addresses of the partitions in the data caches. The first data cache address of the channel partition is stored in the base_address. The last data cache address of the channel partition is stored in the end_address. The number of addresses that should be skipped between 2 consecutive write commands to a same channel partition are concatenated and stored in each of the step_address registers. For example, if the channel partition requires a 512 address partition, and no skipping between 2 consecutive read commands, the channel partition can be mapped in addresses 0-511 of the data cache, that is, base_address=0, end_address=511, and step_address=1, so that no addresses will be skipped between read commands.

When an address pointer reaches the end_address, the address pointer reverts back to the base_address. In case of the FIR accelerator 112, when the address pointer reaches the end_address, then the address pointer, the base_address and the end_address registers can be automatically re-configured by the FIR accelerator 112 with values of a next set of input samples, for further calculations by the accelerator.

In a preferred embodiment of the invention, the following features can be programmed independently in each output FIFO 109:

The output FIFO is programmed to be divided into partitions, one partition for each output channel, for each FIR accelerator 112 and for each IIR accelerators 113, and for each FIR accelerator 113 filter coefficients. Each partition comprises special registers storing the base_address, end_address, and step_address. A first output FIFO buffer 109 address of a channel partition is stored in base_address. A last Output FIFO buffer 109 address of the channel partition is stored in end_address. A number of addresses that should be skipped between 2 consecutive read commands from the same channel partition is stored in step_address. For example, if the channel requires a 16 address partition, and no skipping between 2 consecutive read commands, the channel partition can be mapped in addresses 0-15 of the output FIFO buffer 109, that is, base_address=0, end_address=16, and step_address=1, so that no addresses will be skipped between read commands.

Microcode operating in the MCU 107 fills in the partitions in the output FIFO buffer 109, and when a first frame is ready, for any active I2S/SPDIF channel, the microcode enables the output interface. The output interface recognizes output FIFO buffer 109 partitions which are under the almost_empty threshold, and the output interface activates a DMA process to fill the partitions. The almost_empty threshold is configured in a dedicated register. For example, if a partition consists of 16 addresses, the almost_empty threshold will normally be higher than 0, which indicates that the partition is already empty, and lower than 8, which indicates that only half of the partition is empty.

Appropriate partitions in the output FIFO buffer 109 are filled by audio samples from appropriate partitions in the data cache, until the almost_full threshold is reached. The almost_full threshold is configured in a dedicated register. For example, if the partition consists of 16 addresses, the almost_full threshold will normally be lower than 16, which indicates that the partition is already full, and higher than 8, which indicates that only half of the partition is full.

After an audio sample is read from the output FIFO buffer 109, the audio sample is sign-extended, amplified/attenuated, clipped to a desired number of bits, right aligned in the storage register, and arranged so that a MSB or a LSB can be transmitted first.

In addition to the audio sample itself, the SPDIF interface makes use of special flags and headers for transmission, as detailed in the SPDIF standard specifications. In accordance with the SPDIF standard, a validity bit flag is used to indicate whether main data field bits in a current sub-frame are reliable and/or are suitable for conversion to an analogue audio signal using linear PCM coding. The validity bit flag may be fixed for an entire transmission. A user data bit flag is provided to carry any other information. The user data bit default value is 0. A channel status carries, in a fixed format, data associated with each main data field channel. The channel status data may be fixed for each channel. The MCU 107 transfers each one of the above-mentioned flags and headers to the SPDIF interface in one of the following ways:
1. The microcode of the MCU 107 concatenates the headers and flags to each audio sample, and stores them in the output FIFO buffer 109.
2. For acceleration of microcode performance, the microcode of the MCU 107 can store the validity and user data flags in dedicated registers with appropriate values.
3. To achieve higher performance, the microcode of the MCU 107 can store headers/status bits in two 192 bit dedicated registers, with a bit to be transmitted being selected by an automatically calculated index register. Each 192 bit block of each of the current sub-frames is stored in a 192 bit special register, named channel_status_tb10 and channel_status_tb11, which can be configured by the microcode as follows: the microcode can write/read 4 bytes (32 bits) of data to/from dedicated registers starting at any byte, that is bytes 0-3, bytes 1-4 bytes 2-5, and so on. The SPDIF interface has a channel_status_index register which holds a number of channel status bits to be transmitted. Each sub-frame transmission, the channel_status_index register is incremented by 1, and the channel_status_index register is set to zero each 384 sub-frames. The last bit of the channel_status_index register is used to choose between channel_status_tb10 and channel_status_tb11, the rest of the bits being used to choose the appropriate bit to be transmitted.

The parity bit cannot be pre-configured and needs to be calculated for every sample separately. The calculation of the parity bit can be done either by microcode instructions, after which the parity bit is concatenated to the audio sample and stored in output FIFO buffer 109, or by dedicated hardware, immediately after reading a sample from the output FIFO buffer 109.

When the IIR accelerator 113 or the FIR accelerator 112 are used, audio samples are read from the output FIFO buffer 109 and provided to the accelerators for further calculations.

When the I2S interfaces are in bypass mode, that is, passing the audio samples directly from the MCU 107 to the output interface without processing, the microcode may concatenate a left/right clock bit to each audio sample, and store the audio samples and the left/right clock bit together in the output FIFO buffer 109. Thus, in this mode, the I2S interface can deduce the left/right clock bit directly from the output FIFO buffer 109 instead of generating it.

The audio samples are then transmitted a bit at a time, when for I2S interfaces, the data bits are synchronized with a same clock bit and left/right clock bit.

In a preferred embodiment of the present invention, the output FIFO 109 may be programmed and monitored by the MCU 107, through the control bus 119.

### The Analog Back End 110

The multi-channel Analog Back End (ABE) 110 reads the stored digital uncompressed multi-channel audio samples, with optional embedded copy protection signals, from the output FIFO buffer 109. The ABE 110 preferably formats the stored samples into a plurality of analog transmission standards, such as, by way of a non-limiting example, analog baseband, BTSC, and the like and so on. The ABE 110 converts the stored samples into analog form by using a Digital to Analog Converter (DAC). It is appreciated by those skilled in the art that the DACs should be of high quality, low noise, with sufficient sampling rate to support high quality audio, such as for example 48 KHz, 96 KHz, and 192 KHz, with a resolution of at least 24 bits.

The multi-channel analog audio outputs are transferred from the ABE 110 through the analog audio output 124 to an external sound device, speakers or other audio/video devices. The output format may take form of analog baseband audio, BTSC audio modulated on RF signal, and other such digital formats.

In a preferred embodiment of the present invention, the ABE 110 supports a variety of copy protection schemes, such as, by the way of a non-limiting example, Verance audio watermarking.

A preferred embodiment of the present invention comprises 8 analog baseband channels, and 2 BTSC modulated outputs.

In a preferred embodiment of the present invention, the ABE 110 may be programmed and monitored by the MCU 107, through the control bus 119.

In another preferred embodiment of the present invention, the ABE 110 is in form of a socket of, and connects to, a secure AV analog/digital output module such as described in U.S. patent application Ser. No. 11/603,199 of Morad et al.

### The Digital Back End (DBE) 111

The multi-channel DBE 111 reads stored compressed and uncompressed multi-channel audio packets, with optional embedded copy protection signals, from the output FIFO buffer 109. The multi-channel DBE 111 preferably formats the audio packets, for example by adding appropriate packet headers, CRC and so on, into a plurality of digital transmission standards. The digital transmission standards are, by way of a non-limiting example, I2S and SPDIF. The multi-channel DBE 111 transfers the packets through the digital audio output 125, to an external sound device, to speakers, or to other such audio/video devices. The output format may take form of multi-channel I2S audio, optical SPDIF, SPDIF-RF, digital BTSC, and other alike digital formats.

A preferred embodiment of the present invention comprises 8 digital I2S, baseband, SPDIF Optical, and SPDIF-RF channels, and 2 digital BTSC modulated outputs.

An I2S interface is common to all active I2S channels. The I2S interface reads one word for each channel from the output FIFO buffer 109, and transmits the bits of the word simultaneously, with the same bit_clk and lrclk.

In a preferred embodiment of the present invention, each I2S output interface can be programmed independently to enable the following features:
Output is aligned to a positive edge or a negative edge of the clock.
Word alignment is MSB/LSB first.
Different sample word lengths, in which bits are collected until a word of a specified word length is created, after which the word is stored in the output FIFO buffer 109.
Left/right first, that is programmed which channel is acquired first, a left or a right channel.
Different left/right delay, that is, a delay in bits between a bit in which the left_right_clk changes and a bit in which the data word starts.
Left/right word width select.
Adjustable amplification/attenuation for each data word, independent amplification/attenuation for each channel—left/right.
Adjustable per-channel data clipping range.
Per-channel mute control.
Adjustable frame size. At each frame start, a timestamp is collected, in a dedicated register which the MCU 107 can access. The register is a double buffer register, so that the MCU 107 has enough time to read the register before the register is overwritten. In addition, a dedicated register which counts the number of frames is incremented.
A timestamp flag changes its status whenever a timestamp is sampled, so that together with another register, a frame_counter, the MCU 107 knows when a frame is ready.
Each I2S interface is enabled to choose which clock the I2S interface should use for timestamp sampling, such as a system clock, an external clock and so on.

The SPDIF interface reads a word from an associated partition in the output FIFO buffer 109 whenever the word is needed, that is, when all the former bits have been transmitted. A parity flag is calculated by hardware, and transmitted together with the data.

In a preferred embodiment of the present invention, each SPDIF output interface can be programmed independently to provide the following features:
Different sample word length.
Adjustable amplification/attenuation for each data word, that is, independent amplification/attenuation for each channel—left/right.
Adjustable range of maximum and minimum clipping value for each data word.
Independent mute for each channel.
Adjustable frame size, in order to know when a timestamp represents an end of a frame, and sample the timestamp in hardware to a dedicated register which the MCU 107 can read. The dedicated register is a double buffer register, so that the MCU 107 has enough time to read the dedicated register before it is overwritten.
Selectable coding range, suitable for audio coding. A typical coding range is 20 or 24 bits.
Each SPDIF interface can select which clock the SPDIF interface should use for timestamp sampling.
Each SPDIF interface can receive flags from the MCU 107 in one of several ways, as explained earlier:
   1. The SPDIF interface can read the flags together with audio samples from the Output FIFO buffer 109.
   2. The SPDIF interface can read a validity flag and user data flags from pre-configured dedicated registers.
   3. In case of the channel status bits—the SPDIF interface can read the flags from 2 pre-configured dedicated registers. In a preferred embodiment of the present invention, such registers shall have 192 bit width.
Each SPDIF interface supports non-linear PCM encoded audio bit-stream transmission in accordance with IEC 61937.

In a preferred embodiment of the present invention, the DBE 111 may be programmed and monitored by the MCU 107, through the control bus 119.

In another preferred embodiment of the present invention, the DBE 111 is in form of a socket of, and connects to, a secure AV Analog/Digital output module such as described in U.S. patent application Ser. No. 11/603,199 of Morad et al.

Persons skilled in the art will appreciate that the ABE 110 and the DBE 111 typically read audio samples/packets from the output FIFO buffer 109, and output the packets in a substantially constant data rate. To that end, the MCU 107 can add null packets at the output, or perform rate conversion, to compensate for non-constant or different audio input sample rate, so that the ABE 110 and the DBE 111 interfaces do not overflow, or underflow.

### The FIR Accelerator 112

The FIR accelerator 112 implements finite impulse response (FIR) filtering with a configurable number of taps and a configurable number of audio samples, as follows:

$${Y}_{n} = {\sum }_{i = 0}^{p} {a}_{p - i} \cdot {x}_{n - i} . \qquad Equation 1$$

The FIR accelerator 112 may be configured to process p input samples in a single clock cycle. In a preferred embodiment of the present invention, the FIR accelerator 112 calculates 5 input samples in each clock cycle.

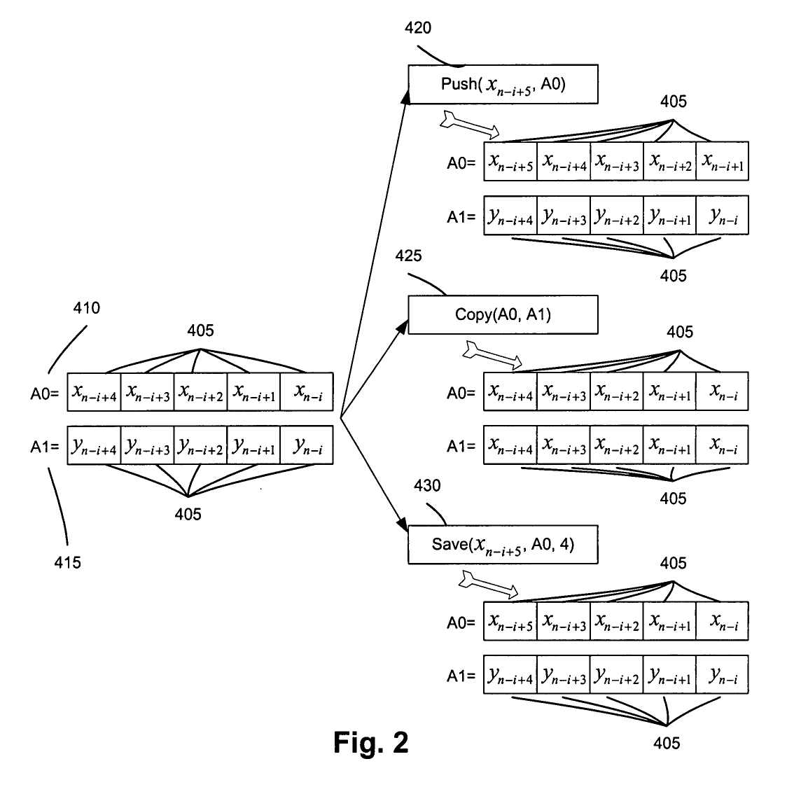

Reference is now made to FIG. 2, which is a simplified functional flow diagram of operations in a FIR accelerator 112 register array in the audio processor 100 of FIG. 1A.

The following terms shall be used herein:
An array of registers: a set of registers 405 of an equal size, in bits, such as A0 410 and A1 415, which are illustrated in FIG. 2.
A push operation 420: shifting contents of a register to its right neighbor register, as illustrated in FIG. 2.
A copy operation 425: copying A1 415 to A0 410, by exact duplication of all registers of A1 into A0, as illustrated in FIG. 2.
A save operation 430: storing a value into an array register, such as A0, with a given index, as illustrated in FIG. 2.
A sample rescale operation: an arithmetic right shift of a register. For example, since a multiplication of 2 fixed-point values of equal length results in a value twice the length, an operation of arithmetic right shift can follow the multiplication in order to scale a result of the multiplication to a fixed-point value of the same length.

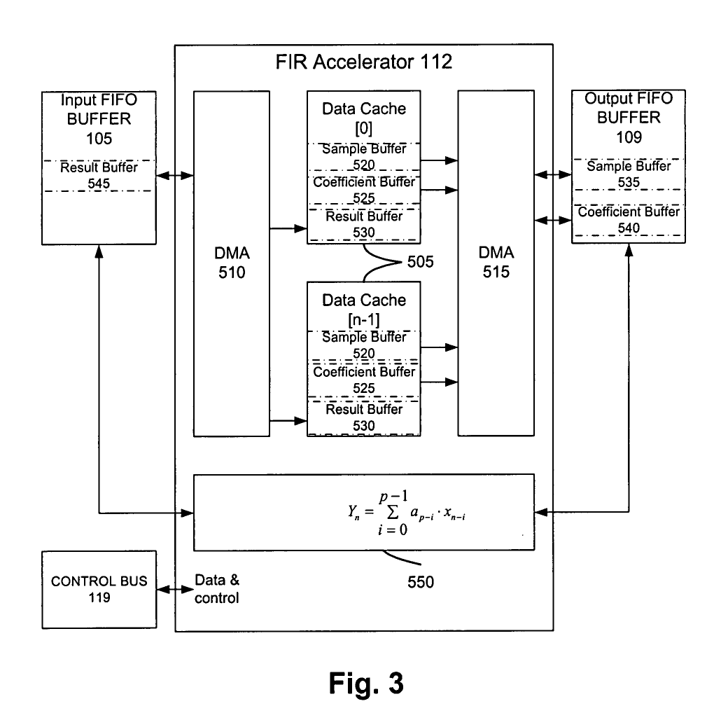

Reference is now made to FIG. 3, which is a simplified functional block diagram of operations of the FIR Accelerator and FIFOs of the audio processor 100 of FIG. 1A. The FIR accelerator comprises several data caches 505, connected to the input FIFO buffers 105 by DMA 510, and to the output FIFO buffers 109 by DMA 515. Each of the data caches 505 comprises a sample buffer 520, a coefficient buffer 525, and a result buffer 530. The sample buffers 520 of the data caches 505 are connected by DMA 515 to a sample buffer 535 in the output FIFO buffer 109. The coefficient buffers 525 of the data caches 505 are connected by DMA 515 to a coefficient buffer 540 in the output FIFO buffer 109. The result buffers 530 of the data caches 505 are connected by DMA 510 to a result buffer 545 in the input FIFO buffer 105.

Buffer sizes are preconfigured by the MCU 107 (FIG. 1B). The number of sample buffers 535 and coefficient buffers 540 in the output FIFO buffer 109 corresponds to the number of sample buffers 520 and coefficient buffers 525 in the data caches 505. The number of result buffers 545 in the input FIFO buffer 105 corresponds to the number of result buffers in the data caches 505.

An equation 550 provided in FIG. 3 describes the mathematical functionality of the FIR accelerator 112. In the equation a is a coefficient, x is a value of a sample, p is an order of the FIR filter being implemented, and n is an index of a series of samples . . . xₙ₋₁, x, xₙ₊₁ . . . . The FIR accelerator 112 reads coefficients a and samples x from the sample buffers 520 and the coefficient buffers 525 in the data caches 505, via the output FIFO buffer 109. A result Yₙ of equation 550 is calculated, and the result Yₙ is stored in the result buffer 530 in the data cache 505 via the input FIFO buffer 105.

The following additional terms are now described:
A read sample/coefficient request: a request for reading from the data caches 505 via the output FIFO buffer 109, as illustrated in FIG. 3.
Write output sample: store a result to the data caches 505 via the input FIFO buffer 105, as illustrated in FIG. 3.
Input samples: samples to be processed.
Output samples: the results of the FIR accelerator 112.
Clock cycle: a completion of processing of p input samples. Corresponds to a calculation of Yₙ of equation 550 in FIG. 3
Calculation cycle: a processing of n output samples. In a preferred embodiment of the present invention, 5 output samples are processed.

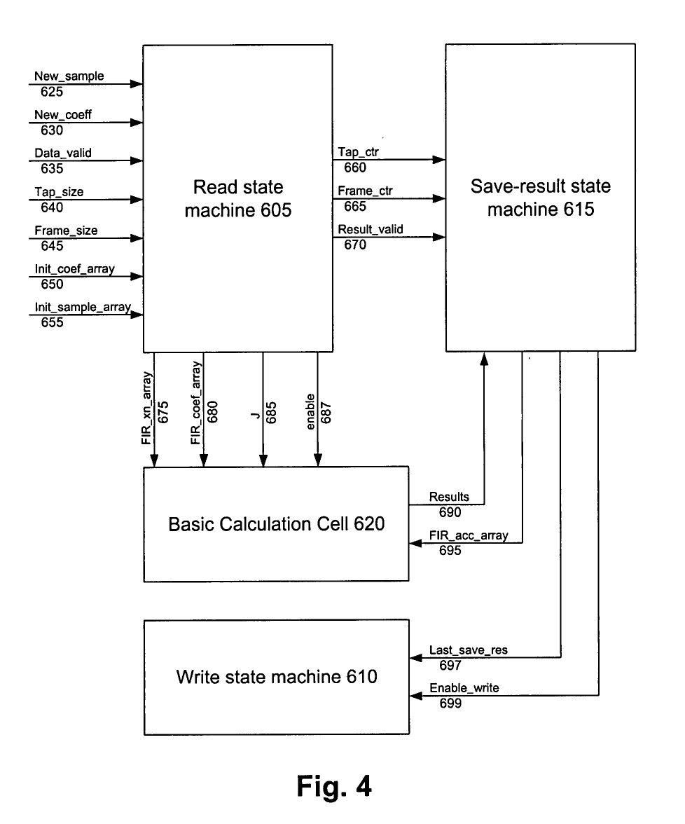

In a preferred embodiment of the present invention, the FIR accelerator 112 comprises a controller, which comprises read, write, and save-result state machines, and a basic calculation cell which operate independently and simultaneously, as illustrated in FIGS. 4-8.

Reference is now made to FIG. 4, which is a simplified functional block diagram of the FIR accelerator 112 of the audio processor 100 of FIG. 1A. The controller comprises the read state machine 605, the write state machine 610, the save-result state machine 615, and the basic calculation cell 620, connected as illustrated in FIG. 4.

The read state machine 605 accepts the following values: New_sample 625 and New_coeff 630 as inputs from the DMA 515 (FIG. 3) via the output FIFO buffer 109, and the following values: Data_valid 635, Tap_size 640, Frame_size 645, Init_coef_array 650, and Init_sample_array 655 as inputs from the MCU 107.

The read state machine 605 provides outputs Tap_ctr 660 Frame_ctr 665 and Result_valid 670 to the save-result state machine 615, and provides outputs FIR_xn_array 675, FIR_coef_array 680, J 685, and enable 687 as inputs to the basic calculation cell 620.

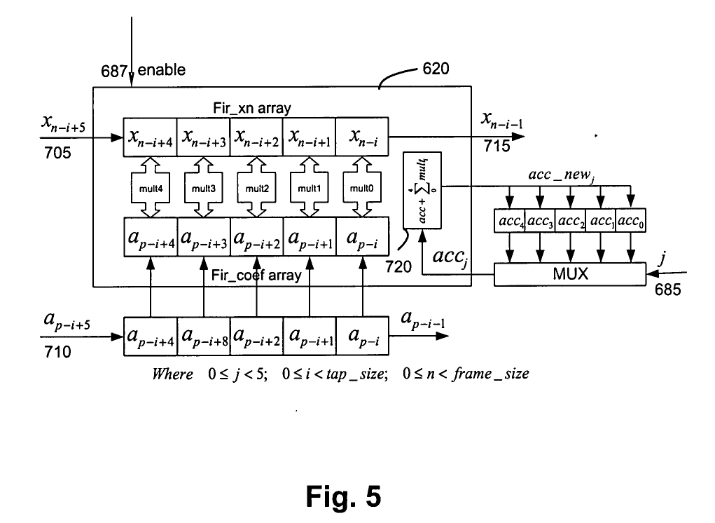

The basic calculation cell 620 performs calculations in discrete steps, and the input J is a step number within one calculation cycle, and the enable signal enables performing a step, as will be further described below with reference to FIGS. 5, 9, and 10.

The basic calculation cell 620 provides output results 690 to the save-result state machine 615, and receives input of FIR_acc_array 695 from the save-result state machine 615.

The save-result state machine 615 provides outputs of Last_save_res 697 and Enable_write 699 to the write state machine 610.

The inputs and outputs of the state machines depicted in FIG. 4 will be further described below, with reference to register definitions for the FIR accelerator 112.

Reference is now made to FIG. 5, which is a simplified flowchart illustration of a basic calculation cell 620 in the FIR accelerator 112 of the audio processor 100 of FIG. 1A. The basic calculation cell 620 performs multiplication of coefficients (a) and samples (x), and accumulates results of the multiplications in accumulator accⱼ 720.

The basic calculation cell 620 accepts as inputs the following values: samples xₙ₋ᵢ₊₅ 705, which are values in the FIR_xn_array 675 of FIG. 4; coefficients aₚ₋ᵢ₊₅ 710, which are values in the FIR_coef_array 680 of FIG. 4; enable 687 from the read state machine 605 (FIG. 4), and J 685 from the read state machine 605 (FIG. 4), and provides output of xₙ₋ᵢ₋₁ 715, which is a value in the results 690 of FIG. 4, to the save-result state machine 615.

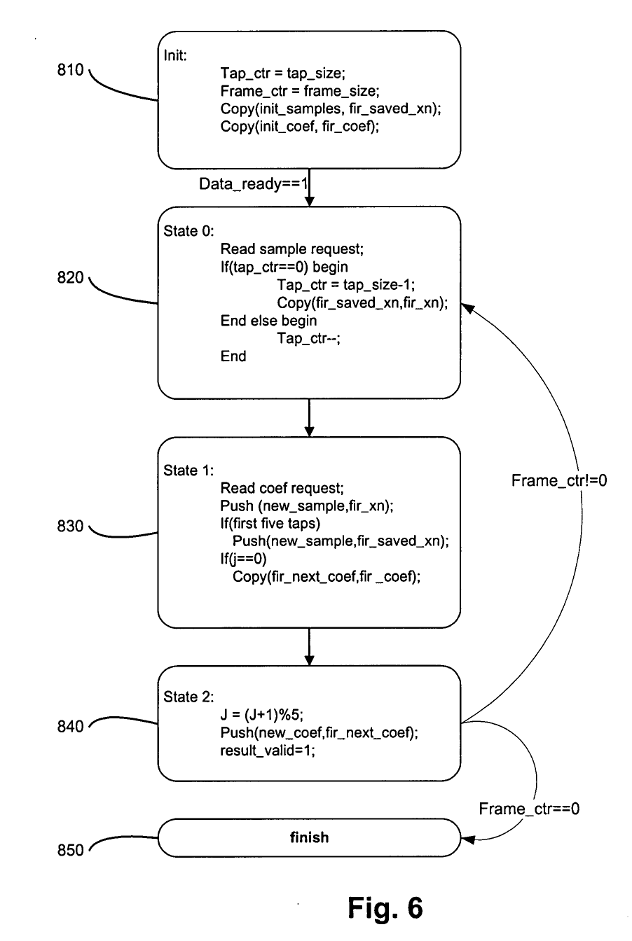

Reference is now made to FIG. 6, which is a simplified flowchart illustration of a read state machine 605 in the FIR accelerator 112 of the audio processor 100 of FIG. 1A. The read state machine 605 preferably comprises 5 states: an initial state 810, state 0 820, state 1 830, state 2 840, and a finish state 850. The read state machine 605 is responsible for fetching new samples and coefficients, setting inputs for the basic calculation cell 620, and signaling the save-result state machine 615 when a result is ready.

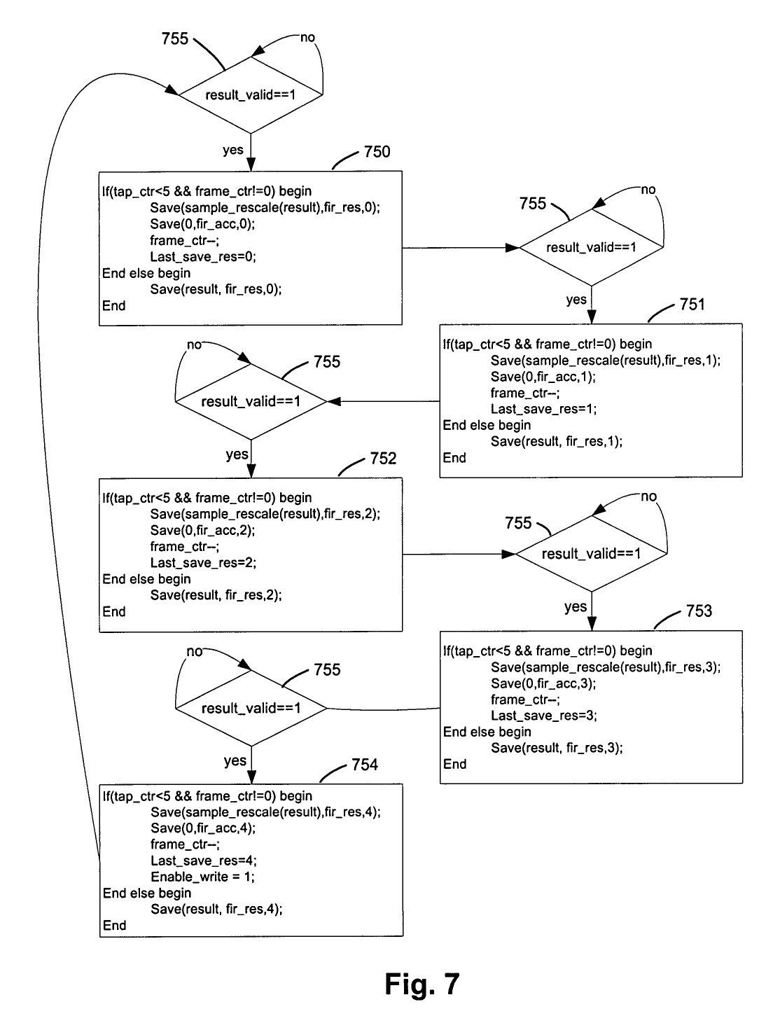

Reference is now made to FIG. 7, which is a simplified flowchart illustration of a save-result state machine 615 in the FIR accelerator 112 of the audio processor 100 of FIG. 1A. The save-result state machine 615 comprises a number, for example 5, of states 750, 751, 752, 753, 754. State 0 of the save-result state machine 615 is referenced by reference 750, state 1 of the save-result state machine 615 is referenced by reference 751, and so on, to state 4 of the save-result state machine 615 being referenced by reference 754.

The save-result state machine 615 reads a result calculated in the basic calculation cell 620, either saves the result in a register array or rescales the temporary result to a desired scaling, and signals the write state machine 610 (FIG. 4) to transfer the result to the data cache 505 (FIG. 3) via the input FIFO buffer 105 (FIG. 3).

In each state 750, 751, 752, 753, 754 of the save-result state machine 615 a result_valid signal 750 is polled. In most cases, if the result_valid signal 750 provides a value indicating that a result is valid, the result is saved in a temporary register array (fir_acc). If a last state of the save-result state machine 615 has been reached, for example state number 4, the save-result state machine 615 scales the result to a desired scaling, saves the result in a result register array (fir_res), initializes the temporary register array (fir_acc), decreases the frame counter (frame_ctr) and saves the state number as the last saved result (Last_save_res).

The save-result state machine 615 signals the write state machine to transfer the temporary result to the data cache 505 (FIG. 3) either after each calculation cycle (state 4), or when reaching an end of the frame (End frame cond).

During operation of the save-result state machine 615 the following test is performed, in order to enable writing:
If(tap_ctr<5 && frame_ctr==1 && result_valid) Enable_write=1;

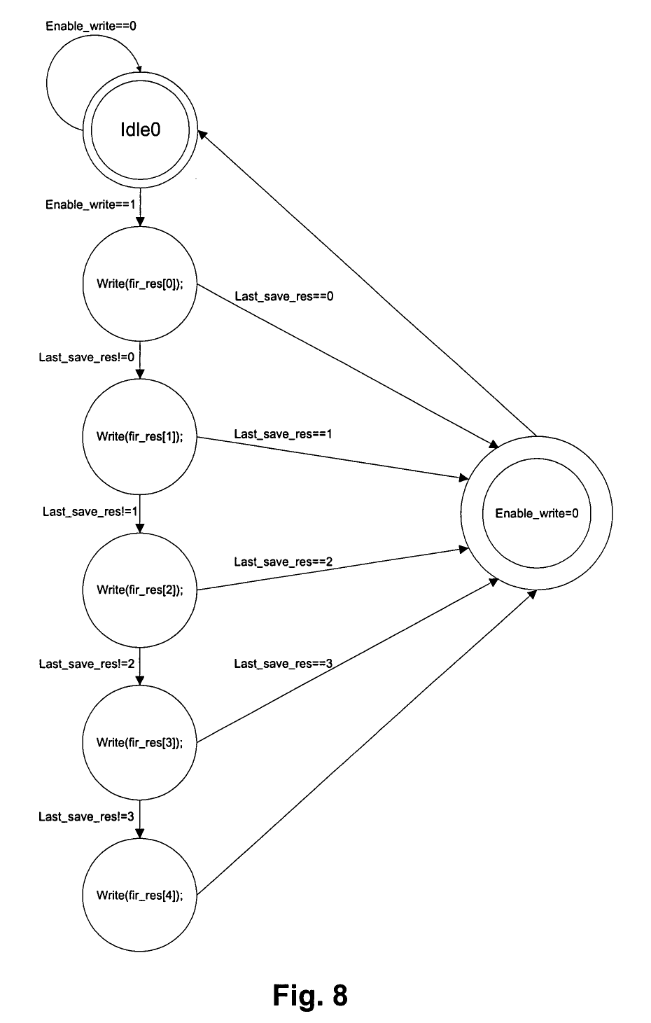

Reference is now made to FIG. 8, which is a simplified flowchart illustration of a write state machine 610 in the FIR accelerator 112 of the audio processor 100 of FIG. 1A. The write state machine 610 transfers a result of the FIR accelerator 112 to the data caches 505 (FIG. 3) via the input FIFO buffer 105. The write state machine 610 waits at an idle state until an enable_write signal is set, after which, at each state, the write state machine 610 writes a result to the data caches 505 (FIG. 3) via the input FIFO buffer 105 (FIG. 3). The write state machine 610 checks if a current state is a last state (last_save_res), and if so, the write state machine 610 sets the enable_write signal to zero and returns to the idle state, else the write state machine 610 continues to a next state.

Both the audio samples to be filtered and the filter coefficients are stored in the data caches 505 (FIG. 3).

The following registers are used in the implementation of the FIR 112:
Frame_size 645 (FIG. 4): a number of audio samples per frame.
Frame_ctr 665 (FIG. 4): counts a number of output samples left to store in the data cache for a current frame.
Tap_size 640 (FIG. 4): a number of coefficients to be used.
Tap_ctr 660 (FIG. 4): counts a number of coefficients left to fetch from the data cache.
Fir_xn (FIG. 6): a register array used for storing input samples to be processed.
Fir_coef (FIG. 6): a register array used to store a coefficient needed for a calculation.
Fir_next_coef (FIG. 6): a register array used to store p coefficients needed for calculation of the next p consecutive steps.
Fir_saved_xn (FIG. 6): a register array used to save the first p input samples needed for a first step of the next calculation cycle.
Init_coef_array 650 (FIG. 4): a register array which contains the first p coefficients needed for a first step of a calculation, as configured by the MCU 107.
Init_sample_array 655 (FIG. 4): a register array which contains the first p input samples needed for a first step of a calculation, as configured by the MCU 107.
   Fir_res (FIG. 7): a register array used to store p output samples to be stored in the data cache.
J 685 (FIG. 4): a register used to choose an accumulator needed for calculation of a current output sample.
accⱼ (FIG. 5): a register used to store a partial result of an output sample.
Last_save_res 697 (FIG. 4): a register used to store a last index of the fir_res register array to be store in the data cache.

In a preferred embodiment of the present invention, p is set to 5.

By way of a non-limiting example, a basic calculation cell of 5 multipliers is used, allowing 5 multiplications of coefficients and input samples at once, that is, a processing of 5 taps. The basic cell also has 5 accumulator registers, for storage of 5 partial results of 5 different output samples.

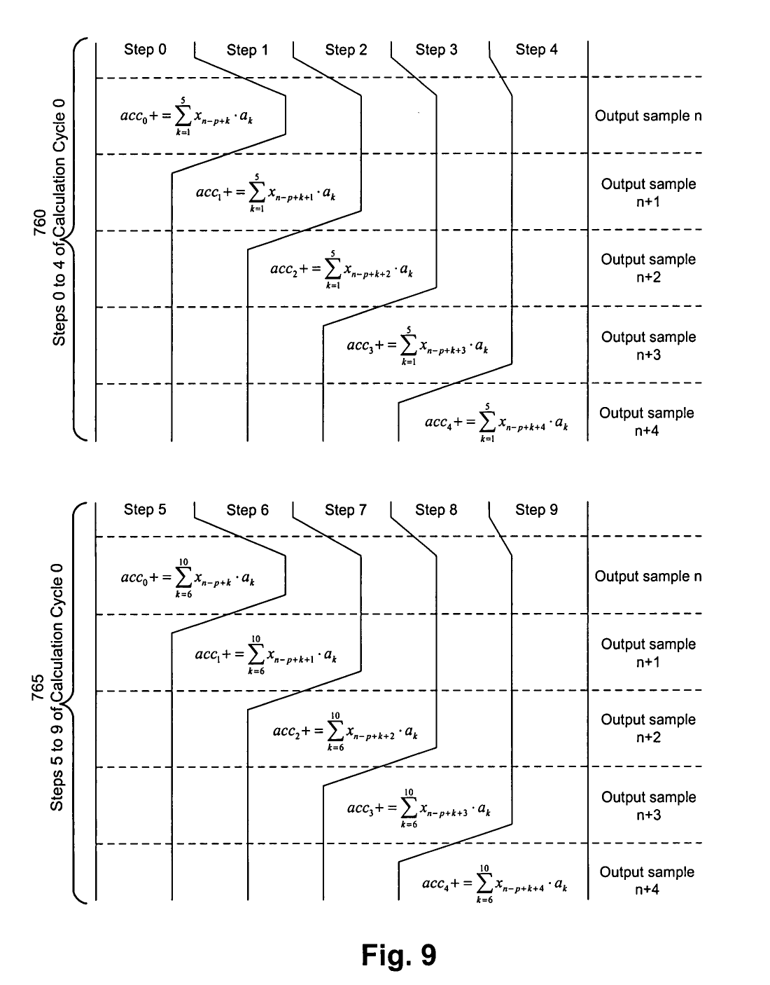

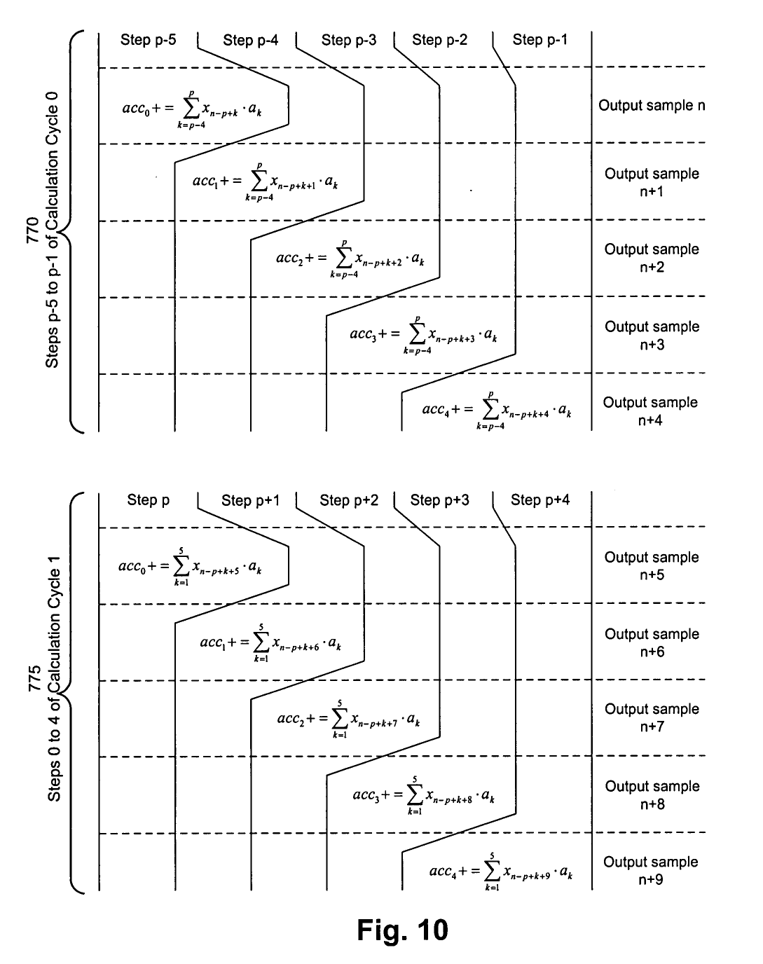

In one calculation step, the basic cell processes 5 taps out of tap_size input samples, for a calculation of one of the 5 output samples (as illustrated in FIGS. 9-10).

Reference is now made to FIG. 9, which is a first simplified functional diagram of calculation steps of the FIR accelerator 112 of the audio processor 100 of FIG. 1A.

FIG. 9 depicts part of a first calculation cycle of the FIR accelerator 112, referenced as steps 0 to 4 of calculation cycle 0 760. Steps 0 to 4 within the calculation cycle 0 760 are accumulated into accumulators acc0, acc1, acc2, acc3, and acc4. The steps 0 to 4 are steps in calculation of output samples n, n+1, n+2, n+3, and n+4.

At steps 0 to 4 within the calculation cycle 0 the FIR accelerator 112 multiplies and accumulates a first 5 input samples needed for calculation of output samples n, n+1, n+2, n+3, and n+4 using the first 5 coefficients a₁, to a₅. Samples xₙ₋ₚ₊₁ to xₙ₋ₚ₊₅ are used for calculating output sample n, samples xₙ₋ₚ₊₂ to xₙ₋ₚ₊₆ are used for calculating output sample n+1, and so on.

At steps 5-9 of calculation cycle 0 765 the FIR accelerator 112 multiplies and accumulates the next 5 input samples needed for the calculation of output sample n+i (where i=0-4) with the next 5 coefficients (a₆ to a₁), i.e. samples xₙ₋ₚ₊₆ to xₙ₋ₚ₊₁₀ for output sample n, samples xₙ₋ₚ₊₇ to xₙ₋ₚ₊₁₁ for output sample n+1 etc.

Reference is now made to FIG. 10, which is a second simplified functional diagram of calculation steps of the FIR accelerator 112 of the audio processor 100 of FIG. 1A.

At steps p−5 to p−1 of calculation cycle 0 770 the FIR accelerator 112 multiplies and accumulates the last 5 input samples needed for the calculation of output samples n+i (where i=0-4) with the last 5 coefficients (aₚ₋₄ to aₚ), i.e. samples xₙ₋₄ to xₙ for output sample n, samples xₙ₋₃ to xₙ₊₁ for output sample n+1 etc.

At steps p to p+4, which are steps 0 to 4 of calculation cycle 1 775 the FIR accelerator 112 multiplies and accumulates the first 5 input samples needed for the calculation of output sample n+i+5 (where i=0-4) with the first 5 coefficients (a₁ to a₅), i.e. samples xₙ₋ₚ₊₆ to xₙ₋ₚ₊₁₀ for output sample n+5, samples xₙ₋ₚ₊₇ to xₙ₋ₚ₊₁₁ for output sample n+6 etc. Each temporary calculation result of output sample n+i is saved at temporary register accᵢ, where accᵢ is an i-th register of a register array fir_acc.

The coefficients are identical for the calculations of all the output samples, thus the basic cell uses the same 5 coefficients during 5 consecutive steps. Each step produces a different output sample. During 5 consecutive steps, the basic cell processes 5 taps for each of the 5 output samples. After tap_size steps, which equals one calculation cycle, 5 output samples out of frame_size output samples are ready in the 5 accumulator registers.

During the 5 consecutive steps in which the basic cell uses the same coefficients, 5 new coefficients are fetched, one new coefficient in each step, and pushed, again one new coefficient in each step, into the fir_next_coef register array. At the end of the 5 steps the fir_next_coef array register contains the coefficients needed for the next 5 steps of calculations. Additionally, during each step a new sample is fetched and pushed to fir_xn register array, so that after 5 consecutive steps the register array contains samples needed for a current output sample calculation. This allows full usage of a pipeline structure without sacrificing steps or cycles for sample/coefficient fetch.

In a preferred embodiment of the present invention, the MCU 107 microcode loads the first 5 coefficients and audio samples into dedicated special register arrays init_sample and init_coef, and signals to the read state machine that the data is ready. The read state machine initializes the tap_ctr and frame_ctr to a size configured by the microcode, and copies the init_coef to the fir_coef and the init_sample to the fir_saved_xn register array.

At a beginning of an operation, the FIR accelerator 112 expects the first 5 samples to be in a register array. The fir_saved_xn register array is used to store the first 5 fetched samples of each calculation cycle during the operation of the FIR accelerator 112, as they are needed for the first step of the next calculation cycle, as described above with reference to FIG. 10.

Since a current calculation cycle uses p samples with offset of 5 samples in accordance to a previous calculation cycle, as depicted in formulas in FIGS. 9 and 10, each calculation cycle has samples read address and end address which are larger by 5 from the previous calculation cycle.

Furthermore, the read address of the output FIFO buffer 109 is cyclic. During the last 5 steps of every calculation cycle, the first 5 coefficients which are needed for the first 5 steps of the next calculation cycle are fetched.

The read/save-result/write state machines operate as follows, as illustrated in FIGS. 6-8:

At state 0 820 (FIG. 6) the read state machine:
1. Sends a read sample request.
2. According to a value of the tap_ctr either decreases the tap_ctr or sets it to tap_size-1.
3. Copies the fir_saved_xn to the last 5 (out of 6) registers of the fir_xn array register.

At state 1 830 (FIG. 6) the read state machine:
1. Pushes the new input sample to fir_xn (now in the first 5 registers we have the 5 input samples to be processed).
2. Sends a read coefficient request.
3. Performs the multiplications of the coefficients and samples.
4. Accumulates the results of the multiplications by the basic calculation cell.

At state 2 840 (FIG. 6) the read state machine:
1. Pushes the next fetched coefficient to the fir_next_coef array register.
2. Perform j=(j+1)% 5.
3. Signals the save result state machine that the result is valid.

Whenever there is a valid result, the save-result state machine, as illustrated in FIG. 7:
1. According to the tap_ctr and frame_ctr, either saves the temporary result of the basic FIR calculation cell in accⱼ, or rescales the final result and saves it in the j-th index of the fir_res array register.
2. Initializes the accⱼ to 0.
3. Decreases the frame_ctr.
4. Sets the last_save_res to j.
5. Sets the enable_write either after collecting 5 output samples (after 1 calculation cycle) or after collecting the last output sample of the frame (when frame_size is not an integral multiple of 5).

The write state machine, as illustrated in FIG. 8:
1. Upon enable_write, writes the output sample to the data cache via input FIFO buffer 105 (as illustrated in FIG. 5).
2. Sets the enable_write to 0 after writing the last output sample.

A number of taps (coefficients) and frame size can be configured by the microcode of the MCU 107. Following processing of an audio frame, the FIR accelerator 112 signals the MCU 107 that output data is ready. The microcode of the MCU 107 decides whether to wait for the output, or to continue performing another instruction simultaneously.

Preferably, once the MCU 107 transfers an operand to the FIR accelerator 112, the MCU 07 continues processing other commands in parallel with the operation of the FIR accelerator 112. The MCU 107 may receive an interrupt from the FIR accelerator 112, via a dedicated pre-configured interrupt vector, or may alternatively poll the status of the FIR accelerator 112, so as to fetch processing results from the FIR accelerator 112 as soon as the results become available. It is to be appreciated by those skilled in the art, that the FIR accelerator 112 relieves the MCU 107 from performing iterative multiplication and addition operations which could consume significant processing time and power.

In a preferred embodiment of the present invention, the FIR accelerator 112 may be programmed and monitored by the MCU 107, through the control bus 119.

### The IIR Accelerator 113

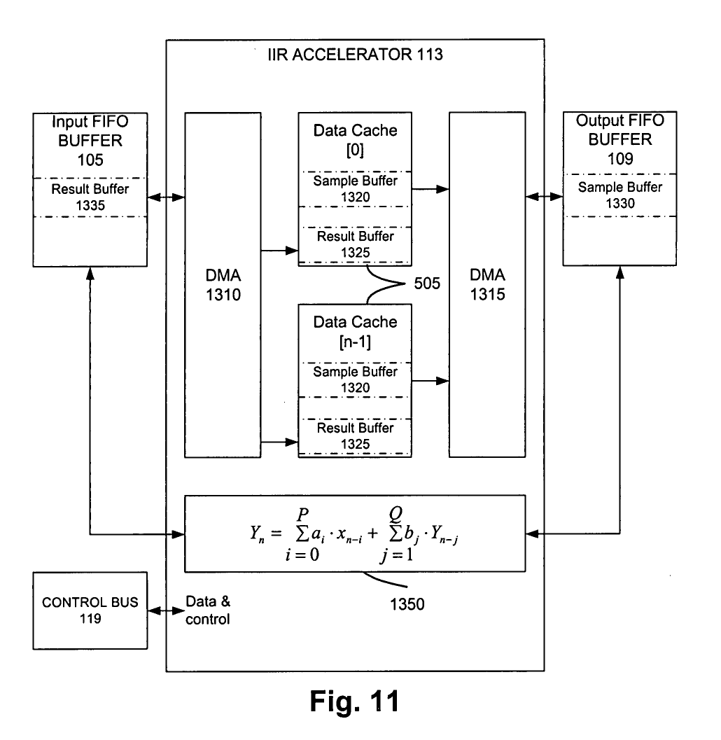

Reference is now made to FIG. 11 which is a simplified functional diagram of an IIR accelerator 113 in the audio processor 100 of FIG. 1A. The IIR accelerator 113 comprises several data caches 505, connected to the input FIFO buffers 105 by a DMA 1310, and to the output FIFO buffers 109 by a DMA 1315. Each of the data caches 505 comprises a sample buffer 1320 and a result buffer 1325. The sample buffers 1320 of the data caches 505 are connected by the DMA 1315 to a sample buffer 1330 in the output FIFO buffer 109. The result buffers 1325 of the data caches 505 are connected by the DMA 1310 to a result buffer 1335 in the input FIFO buffer 105.

Buffer sizes are preconfigured by the MCU 107 (FIG. 1B). The number of sample buffers 1330 in the output FIFO buffer 109 corresponds to the number of sample buffers 1320 in the data caches 505. The number of result buffers 1335 in the input FIFO buffer 105 corresponds to the number of result buffers in the data caches 505.

An equation 1350 provided in FIG. 11 describes the mathematical functionality of the IIR accelerator 113. The IIR accelerator 113 reads samples xᵢ from the sample buffers 1320, and uses feed-forward filter coefficients aᵢ, feedback filter coefficients bⱼ, and output signals from previous time bins Yₙ₋ⱼ, to calculate an output signal at time bin Yₙ. The out signal Yₙ, which is a result of the equation 1350, is stored in the result buffer 1325 in the data cache 505 via the input FIFO buffer 105.

The IIR accelerator 113 is a state machine designed to perform an N-th order IIR filter on a configurable frame size of audio samples, i.e.:

$${Y}_{n} = {\sum }_{i = 0}^{P} {a}_{i} \cdot {x}_{n - i} + {\sum }_{j = 1}^{Q} {b}_{j} \cdot {Y}_{n - j} \qquad Equation 2$$

In the equation above,
P represents the feed-forward filter order.
aᵢ represents the feed-forward filter coefficients
Q represents the feedback filter order.
bⱼ represents the feedback filter coefficients
xₙ represents the input signal at time bin n.
Yₙ represents the output signal at time bin n.

In a preferred embodiment of the present invention, the IIR accelerator performs up to 7^{th} order filtering, i.e. 0≦P≦7; 1≦Q≦7.

The following terms shall be used herein:
An array of registers: a set of registers of equal bits size. An array as referred to with reference to the IIR accelerator 113 is similar to the array illustrated in FIG. 2, with reference to the FIR accelerator 112.
A push operation: shifting a register's content to its right neighbor register. A push operation as referred to with reference to the IIR accelerator 113 is similar to the push operation illustrated in FIG. 2, with reference to the FIR accelerator 112.
A sample rescale operation: an arithmetic right shift of a register. A multiplication of 2 fixed-point values of the same length results in a value twice as long. Therefore, an operation of arithmetic right shift is needed in order to display the result as fixed-point of the same length. Likewise a multiplication of a sample with a fixed-point value result a fixed-point value. Therefore, an operation of arithmetic right shift is needed in order to display the result as a sample.
A write output sample: stores the result to the data cache 505 via the input FIFO buffer 105 (as illustrated in FIG. 11).
Input samples: samples to be processed.
Output samples: the result of the IIR.
Calculation cycle: processing of 1 output sample Yₙ (of equation 1350 of FIG. 11).

The following registers are used in the implementation of the IIR accelerator 11:
Frame_size: a number of audio sample frames to be processed.
Frame_ctr: counts the number of output samples remaining for storage in the data cache 505.
Iir_xn: a register used for storing input samples to be processed.
Iir_coef: a register array used for storing a coefficient needed for calculation.
Iir_yn: a register used for storing output samples of previous calculation cycles.
Acc: a register used to store a partial result of an output sample.

By way of a non-limiting example, the IIR accelerator 113 comprises 5 multipliers, and performs 5 multiplications of input samples and corresponding coefficients during each calculation cycle. The IIR accelerator 113 has comprises an accumulator register, for storage of partial results of 5 multiplications during the calculation cycle.

Audio samples to be filtered are stored in the data cache 505, and coefficients are stored in dedicated registers, iir_coef, which are configured by the MCU 107.

The microcode of the MCU 107 signals the IIR accelerator 113 that data is ready by writing into a dedicated register.

### The IIR Accelerator 113:

1. Automatically fetches a new audio sample from the data cache via the output FIFO 109, as illustrated in FIG. 11.
2. Pushes the new audio sample into the iir_xn register.
3. Performs 5 multiplications of coefficients and samples.
4. Accumulates results of the multiplications and stores the results in an accumulator register acc.
5. If all the multiplications are done, sets the accumulator register acc to 0, rescales the results and pushes the results into the iir_yn register, if not goes back to 3.
6. Stores the rescaled results back in the data cache 505 via the input FIFO buffer 105.

For a next calculation cycle, the accelerator requires both a new audio sample and the last calculated output sample. By pushing the new audio sample into the iir_xn register and pushing the last calculated output sample into the iir_yn register, data for the next calculation cycle is prepared.

The IIR order, that is, the number of coefficients, and frame size, can be configured by the microcode of the MCU 107. In addition the microcode of the MCU 107 can signal the IIR accelerator 113 to round output data to a nearest integer.

The MCU 107 can read and write to the iir_xn and iir_yn registers through the control bus 119, which enables saving and restoring a last state of the IIR accelerator 113, and resetting a state of the IIR accelerator 113.

After processing a single frame, the IIR accelerator 113 signals the MCU 107 that output data is ready by asserting a dedicated register which the MCU 107 can poll, and by issuing an interrupt to the MCU 107.

Preferably, once the MCU 107 transfers the operand to the IIR accelerator 113, the MCU 107 may continue processing other commands in parallel with the operation of the IIR accelerator 113. The MCU 107 may receive an interrupt from the IIR accelerator 113 by a dedicated pre-configured interrupt vector, and may alternatively poll the status of the IIR accelerator 113, so as to fetch results from the IIR accelerator 113 as soon as the results become available. It is to be appreciated by those skilled in the art, that the IIR accelerator 113 relieves the MCU 107 from performing iterative multiplication and addition operations which could consume significant processing time and power.

### The Logarithmic Accelerator 114

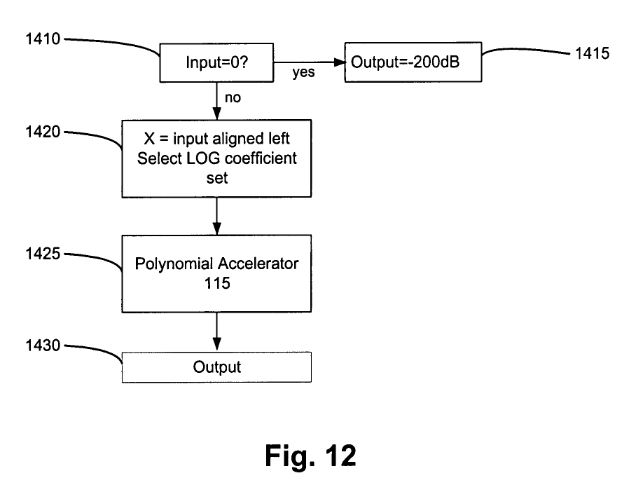

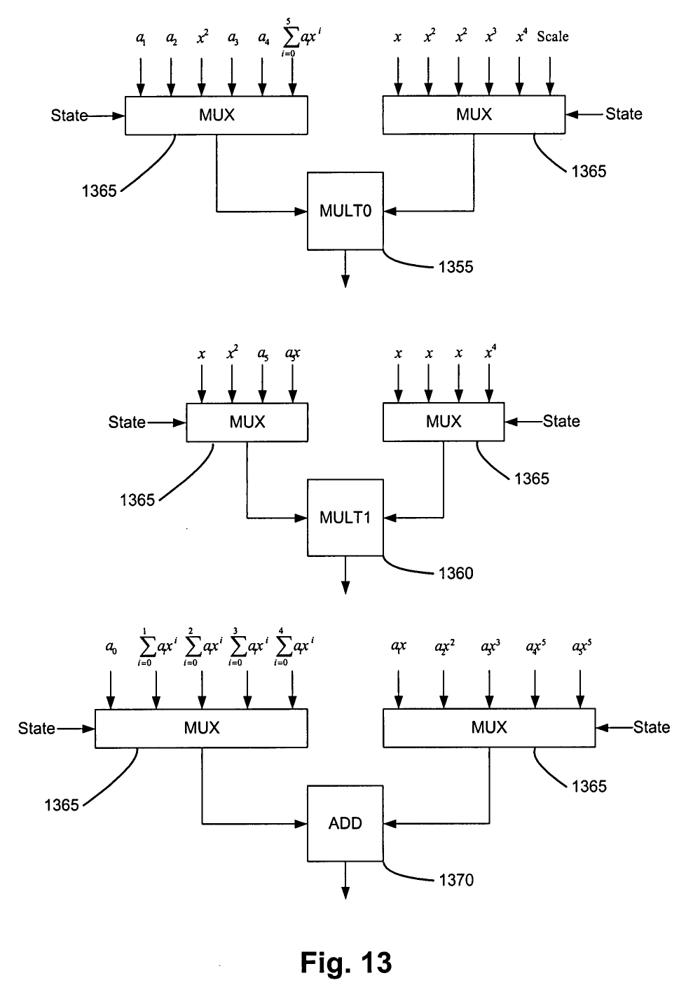

Reference is now made to FIG. 12 which is a simplified flow chart of a logarithmic accelerator 114 of the audio processor 100 of FIG. 1A. The logarithmic accelerator 114 uses the hardware of the polynomial accelerator 115 as described additionally below with reference to FIG. 13.

The logarithmic accelerator 114 is a state machine designed to accelerate calculation of the logarithm in base 10 of a given number x, i.e.

res=10·log₁₀x. Equation 3

The logarithmic accelerator 114 uses an Nth degree polynomial approximation for a log function. In a preferred embodiment of the present invention, a 5th degree is used.

An input operand x is provided by the MCU 107 into a dedicated register. Polynomial coefficients and the degree are stored in a dedicated register immediately after reset, and can also be re-configured by the MCU 107 at a later stage. The MCU 107 signals the logarithmic accelerator 114 when data is ready via a dedicated register.

The logarithmic accelerator 114 checks whether the input operand x is zero (step 1410). If the input operand is zero, the logarithmic accelerator 114 returns a minimum value of −200dB (step 1415). If the input operand is not zero, the logarithmic accelerator 114 feeds the number x, the polynomial coefficients, and a scale and an offset (step 1420) into the polynomial accelerator 115 (step 1425), and waits for the polynomial accelerator 115 to return a result (step 1430).

In a preferred embodiment of the present invention, the logarithmic accelerator 114 completes its task in 14 cycles.

Preferably, once the MCU 107 transfers an operand to the logarithmic accelerator 114, the MCU 107 may continue processing other commands in parallel with the operation of the logarithmic accelerator 114. The MCU 107 may receive an interrupt from the logarithmic accelerator 114, via a dedicated, pre-configured, interrupt vector, and the MCU 107 may alternatively poll the status of the logarithmic accelerator 114 so as to fetch results of the logarithmic processing from the logarithmic accelerator 114 as soon as the results become available. It will be appreciated by those skilled in the art that the logarithmic accelerator 114 relieves the MCU 107 from performing iterative logarithmic calculations which could consume significant processing time and power consumption.

In a preferred embodiment of the present invention, the logarithmic accelerator 114 may be programmed and monitored by the MCU 107, through the control bus 119.

### The Polynomial Accelerator 115

Reference is now made to FIG. 13 which is a simplified functional diagram of an embodiment of a polynomial accelerator 115 in the audio processor 100 of FIG. 1A.

The Polynomial Accelerator 115 is a state machine designed to calculate a N^{th} degree polynomial of a given number x, that is:

$$res = {\sum }_{i = 0}^{N} {a}_{i} \cdot {x}^{i} \qquad Equation 4$$

Polynomial coefficients can be chosen out of several coefficient sets stored in dedicated registers, which are configured immediately after reset. The dedicated registers can also be re-configured later by the MCU 107.

In a preferred embodiment of the present invention, three coefficient sets are used, each containing 6 coefficients, and the polynomial degree is set to 5. A coefficient set is selected by a dedicated register, configured by the MCU 107, by the logarithmic accelerator 114, or by the add-dB Accelerator 116. The operand x is stored in a dedicated register, configured either by the MCU 107, by the logarithmic accelerator 114, or by the add-dB accelerator 116. One of the MCU 107, the logarithmic accelerator 114, and the add-dB accelerator 116 can signal the polynomial accelerator 115 that data is ready, using a dedicated register.

The polynomial accelerator 115 uses multiplexers and several multipliers for calculation of the polynomial value. On a last cycle, a result can be scaled (multiplied) by a pre-configured dedicated register. In a preferred embodiment of the present invention, the polynomial accelerator 115 completes its task in 11 cycles.

FIG. 13 depicts a possible embodiment of the polynomial accelerator 115. The polynomial accelerator 115 calculates 5^{th} degree polynomials using 2 multipliers, MULT0 1355 and MULT1 1360, 6 multiplexers 1365, and 1 adder 1370. In each state, all the multiplexers 1365 select appropriate inputs, and pass the inputs to the multipliers 1355 1360 and adder 1370. For example, at state 0 of the polynomial accelerator 115 state machine, MULT0 1355 multiplies a₁, and x, and MULT1 1360 multiplies x and x. At state 1, when the multiplication results are ready, the adder 1370 adds aₒ and a₁x. At the same state 1, MULT0 1355 multiplies a₂ and x², while MULT1 1360 multiplies x² and x. This process of multiplications and additions continue until the entire polynomial

$${\sum }_{i = 0}^{5} {a}_{i} {x}^{i}$$

has been calculated. On the last stage MULT0 1355 scales the calculation result by multiplying

$${\sum }_{i = 0}^{5} {a}_{i} {x}^{i}$$

with a value which was set in a dedicated register named ‘scale’.

In a preferred embodiment of the present invention, the hardware of the polynomial accelerator 115 is shared with the logarithmic accelerator 114 and with the add-dB accelerator 116. The sharing enables each of the logarithmic accelerator 114 and the add-dB accelerator 116 to activate the state machine of the polynomial accelerator 115 for calculation of polynomial values. Furthermore, the FIR accelerator 112, the IIR accelerator 113, the logarithmic accelerator 114, the polynomial accelerator 115, and the add-dB accelerator 116 share the same multipliers and coefficient registers, and the FIR accelerator 112 and the IIR accelerator 113 also share the same accumulator.

Persons skilled in the art will appreciate that sharing the hardware of the accelerators, leads to smaller silicon area and less power, at a cost of limiting simultaneous activation of the accelerators by the MCU 107.

Preferably, once the MCU 107 transfers an operand into the polynomial accelerator 115, the MCU 107 may continue processing other commands in parallel with the operation of the polynomial accelerator 115. The MCU 107 may receive an interrupt, via a dedicated pre-configured interrupt vector, and may alternatively poll the status of the polynomial accelerator 115 so as to fetch results of the polynomial processing from the polynomial accelerator 115 as the results become available. It will be appreciated by those skilled in the art, that the polynomial accelerator 115 relieves the MCU 107 from performing iterative polynomial calculations which could consume significant processing time and power consumption.

In a preferred embodiment of the present invention, the polynomial accelerator 115 may be programmed and monitored by the MCU 107, through the control bus 119.

The add-dB Accelerator 116:

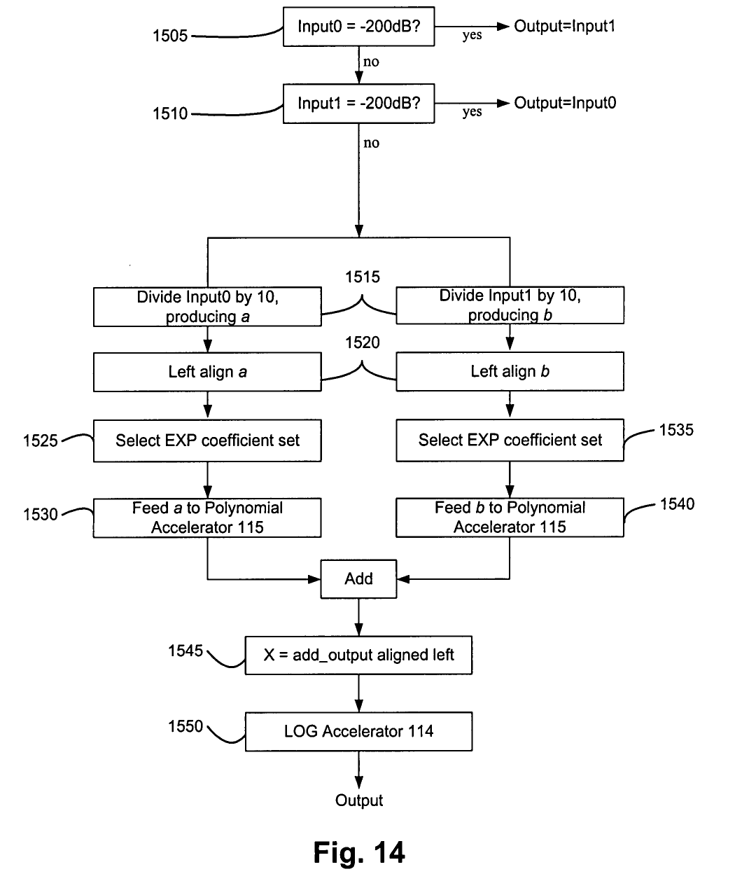

Reference is now made to FIG. 14 which is a simplified flow chart of an add-dB accelerator 116 of the audio processor 100 of FIG. 1A.

In a preferred embodiment of the present invention the add-dB accelerator 116 uses the hardware of the logarithmic accelerator 114 and of the polynomial accelerator 115 as described above with reference to FIG. 13.

In another preferred embodiment of the present invention, the add-dB accelerator 116 comprises hardware similar to that described above with reference to the logarithmic accelerator 114 and of the polynomial accelerator 115.

The add-dB accelerator 116 is calculates a sum of 2 operands which are input in dB units, and returns a result in dB units, as follows:

Given a first operand a, where a=10·log₁₀ x₁

Given a second operand b, where b=10·log₁₀ x₂

The result is res=10·log₁₀(xᵢ+x₂).

For that purpose, the Add dB Accelerator 116 performs the following steps:
1. Checks if a first input, termed input0, equals −200 dB (step 1505). −200 dB is a value small enough to be considered substantially 0 for calculations. If input0 is −200 dB or less, output is set to be equal to a second input, termed input1.
2. Checks if input1 equals −200 dB (step 1510). If input1 is −200 dB or less, output is set to be equal to input0.
3. Divides each of the inputs by 10 (step 1515), thus producing

a=log₁₀ x₁;b=log₁₀ x₂
4. Aligns each of the results a and b to the left of their registers (step 1520).
5. Using polynomial coefficients of an exponent approximation (step 1525), feeds the number a into the polynomial accelerator 115 (step 1530) and waits for a result, thus producing:

10^{a}=x₁
6. Using polynomial coefficients of an exponent approximation (step 1535), feeds the number b into the polynomial accelerator 115 (step 1540), and waits for a result, thus producing:

10^{b}=x₂
7. Sums x₁ and x₂ to producing a partial result, and left aligns the partial result (step 1545):

temp_res=x₁+x₂
8. Feeds the partial result into the logarithmic accelerator 114 and waits for a final result (step 1550):

res=10·log₁₀(x₁+x₂)

In a preferred embodiment of the present invention, the add-dB accelerator 116 completes its task in 53 cycles.

Preferably, once the MCU 107 transfers an operand into the add-dB accelerator 116, the MCU 107 may continue processing other commands in parallel with the operation of the add-dB accelerator 116. The MCU 107 may receive an interrupt, via a dedicated pre-configured interrupt vector, and may alternatively poll the status of the add-dB accelerator 116 so that the MCU 107 may fetch results of the processing of the add-dB accelerator 116 from the add-dB accelerator 116 as soon as the results become available. It will be appreciated by those skilled in the art that the add-dB accelerator 115 relieves the MCU 107 from performing iterative polynomial calculations which could consume significant processing time and power consumption.

In a preferred embodiment of the present invention, the Add dB Accelerator 116 may be programmed and monitored by the MCU 107, through the control bus 119.

### The SORT Accelerator 117:

The SQRT accelerator 117 computes a square root of an unsigned integer operand x, producing \sqrt{x}. In a preferred embodiment of the present invention, the operand x is stored in a dedicated 32 bit register configured by the MCU 107. The MCU 107 signals the SQRT accelerator 117 when data is ready by writing into a dedicated register. The SQRT accelerator 117 may also perform roundup to a nearest integer. In a preferred embodiment of the present invention, the SQRT accelerator 117 uses the following algorithm:

| | |
|---|---|
| Init: | mask = 1<<30 |
| | remainder = operand (x) |
| | root=0 |
| Step: | while (mask) { |
| | If(root+mask<=remainder){ |
| | Remainder = Remainder − (root+mask) |
| | Root = Root + (mask<<1) |
| | } |
| | Root = (root>>1) |
| | Mask = (mask>>2) |
| | } |
| | If(remainder > root && roundup) |
| | Root++ |
| | Return root |

In a preferred embodiment of the present invention, the above calculation is complete in up to 16 cycles.

Preferably, once the MCU 107 transfers an operand into the SQRT accelerator 117, the MCU 107 may continue processing other commands in parallel with the accelerator operation. The MCU 107 may receive an interrupt, via a dedicated pre-configured interrupt vector, and may alternatively poll the status of the SQRT accelerator 117 so it may fetch the results of the SQRT processing from the SQRT accelerator 117 as soon as these results become available. It will be appreciated by those skilled in the art, that the SQRT Accelerator 117 relieves the MCU 107 from performing iterative polynomial calculations which could consume significant processing time and power consumption.

In a preferred embodiment of the present invention, the SQRT Accelerator 117 may be programmed and monitored by the MCU 107, through the control bus 119.

### The Population Count Accelerator 118:

The population count accelerator 118 is designed to calculate the number of logical “1” appearances in an unsigned integer number. In a preferred embodiment of the present invention, the operand is stored in a dedicated 32 bit register, named sp_pop_cnt_in, which is programmed by the MCU 107. The result of the population count accelerator 118 is stored in another dedicated register, named pop_count_number_ones, accessible by the MCU 107. The population count accelerator 118 can be used, for example, to increase performance of the audio processor 100 when calculating audio watermarking.

The population count accelerator 118 preferably uses the following algorithm:

```
            pop_cnt_w = sp_pop_cnt_in −
            (sp_pop_cnt_in[31:1] & m1);
            pop_cnt_x = (pop_cnt_w & m2) +
            (pop_cnt_w[31:2] & m2);
            pop_cnt_c = (((pop_cnt_x + pop_cnt_x[31:4]) & m3) *
            m4);
            output = pop_cnt_c[29:24];
      where m1 = 0x55555555; m2 = 0x33333333; m3 = 0x0f0f0f0f;
m4 = 0x01010101.
```

In a preferred embodiment of the present invention, the above calculation is performed in a single clock cycle.

Preferably, once the MCU 107 transfers an operand into the population count accelerator 118, the MCU 107 may continue processing other commands in parallel with the operation of the population count accelerator 118. The MCU 107 may receive an interrupt, via a dedicated pre-configured interrupt vector, and may alternatively poll the status of the population count accelerator 118 so that the MCU 107 may fetch results of the population count processing from the population count accelerator 118 as soon as the results become available. It will be appreciated by those skilled in the art, that the population count accelerator 118 relieves the MCU 107 from performing population count calculation which could consume significant processing time and power consumption.

In a preferred embodiment of the present invention, the population count accelerator 118 may be programmed and monitored by the MCU 107, through the control bus 119.

Typical operation of the audio processor 100 of FIG. 1A is now described.

In a preferred embodiment of the present invention, one or more bit-streams, from one or more sources are processed by the audio processor 100 simultaneously.

The bit-streams comprise, by way of a non-limiting example, audio samples, embedded data, embedded security codes, multiplexed audio packets, and other types of media bit-streams.

The one or more sources comprise, by way of a non-limiting example, an external memory device, via the SMC 106; an external host or source, such as, by way of a non-limiting example, cable or satellite or terrestrial TV feed, or DVD, HD-DVD, CVR, camcorder, or additional external CE appliance, or Internet, or local network, connected to either the Host/Switch 108, or to the AFE 101 or the DFE 102.

The MCU 107 de-packetizes and demultiplexes compressed and uncompressed audio streams, performs audio decompression and/or compression according to various audio standards (such as Dolby AC3, DTS etc), performs rate change conversion, volume control, loudness, equalizer, balance, treble-control, channel down-mix, up-mix, pseudo-stereo, psycho-acoustic modeling, extracts and embeds data codes, decrypts encrypted audio streams, identifies and/or embeds security watermarks, encrypts streams, multiplexes streams, reads and/or stores streams on external storage devices, plays streams using the ABE 110 and the DBE 111 interfaces, acquires and/or embeds timestamps, plays streams based on certain timestamps, and any combination thereof.

Preferably, the MCU 107 also blends multiple uncompressed audio channels together, in accordance with control commands. The control commands may be provided via the Host/Switch interface 108. Preferably, the MCU 107 acquires timestamps for incoming analog and digital compressed and/or uncompressed streams. The MCU 107 multiplexes timestamp data during the compression and multiplexing process. MCU 107 uses the de-multiplexed timestamps which are embedded in the compressed and/or multiplexed streams during playback, in-order to ensure lip-sync, that is audio tracking.

In a preferred embodiment of the present invention, the MCU 107 produces packet headers and assigns relevant timestamps automatically.

Each input channel has a dedicated register for counting audio samples, and a dedicated register configured with a number of samples per audio frame. Whenever the audio sample counter reaches the number of samples per frame, a reference clock is sampled into a timestamp register. Several timestamp registers may serve each channel, each timestamp register having a flag which toggles (0/1) whenever a timestamp is sampled.

In a preferred embodiment of the present invention, two timestamp registers are provided per channel, sharing one timestamp flag. If the timestamp flag has a value 0, then the timestamp is sampled into the first timestamp register. Otherwise, the timestamp is sampled into the second timestamp register. A change in timestamp flag status signals a microcode program that a new frame is ready for processing, and the MCU 107 can read the timestamp from a corresponding register.

It is to be appreciated that two timestamp registers operate as a double buffer, thus preventing the possibility of overriding a timestamp register in case the MCU 107 did not sample timestamp register in time. There are also two partitions in the data cache 505 for each channel, each partition having a size of an entire audio frame, for the same purpose.

In another preferred embodiment of the present invention, the MCU 107 inputs timestamps, and additional data associated with input audio streams, from one or more sources. The additional data includes, by way of a non-limiting example, tagging and indexing tables associated with the bitstreams.

The packetizing, multiplexing, compression, and decompression are performed according to a variety of system standards, including, by way of a non-limiting but typical example, MPEG2, MPEG4, and DV. The MCU 107 enables changing system standards and multiplexing parameters through programming.

The MCU 107 can compress, decompress, and multiplex a plurality of input audio bit-streams into a single packetized multiplexed stream, and a plurality of packetized multiplexed streams, as needed.

The packetized multiplexed stream or streams, produced by the MCU 107, are typically stored into one or more output FIFO buffers 109.

A preferred embodiment of the present invention also stores the compressed or uncompressed audio streams and the packetized multiplexed stream or streams on external memory via the SMC 106, or on an external device via the Host/Switch interface 108.

Typical operation of the audio processor 100 of FIG. 1A, in de-multiplexing mode and decoding mode, is now described.

In a preferred embodiment of the present invention, the audio processor 100 inputs one or more compressed or uncompressed audio bit-streams, from one or more sources.

The bit-streams are comprised, by way of a non-limiting example, of transport streams, program streams, uncompressed audio, compressed audio, and similar type streams, comprising, by way of a non-limiting example, multi-channel audio and data.

The one or more sources comprise: an external memory device, via the SMC 106; an external host, via the Host/Switch interface 108; and the one or more analog audio inputs 120 and the digital audio inputs 121 via the AFE 101 and the DFE 102.

It is to be appreciated that a bit-stream may be input into the audio processor 100 by other routes, such as from the memory interface 122 via the SMC 106, and from the Host/Switch I/O 123 via the Host/Switch interface 108. In such cases the MCU 107 may additionally process the bit-stream, performing functions typically assigned to the AFE 101 and DFE 102 and to the data filters 103 104, such as, by way of a non-limiting example, pre-filtering and formatting for a specific stream.

The processed bit-stream data, along with associated process data, is output to external devices. The external devices comprise an external memory, accessed via the SMC 106, an external device accessed via the Host/Switch interface 108, and the output interfaces via the ABE 110 and the DBE 111.

It is to be appreciated that the MCU 107 preferably monitors, provides controls signals, and schedules other components within the audio processor 100, as appropriate, via the control bus 119.

A preferred embodiment of the present invention supports simultaneous multiplexing and de-multiplexing, encoding and decoding of multi-channel streams. In a preferred embodiment of the present invention, the audio processor 100 supports de-multiplexing and decoding of 7 different input multiplexed compressed audio streams and encoding & multiplexing of 2 independent output audio streams

It is to be appreciated that the audio streams are received from the analog audio input 120, the digital audio input 121, and the Host/Switch I/O 123, using a variety of communication standards.

In yet another preferred embodiment of the invention, the audio processor 100 operates in trans-coding mode. In trans-coding mode, several streams are acquired and decoded following the decoding/de-multiplexing mode described above. The streams are preferably enhanced, for example by applying processing and filtering such as volume control, loudness, equalizer, balance, treble-control, channel down-mix, up-mix, pseudo-stereo and so on, and are further encoded and multiplexed following the decoding/de-multiplexing mode described above. The encoded streams are further transmitted, or stored in the manner described above.

Operation of the SMC 106 is now described in more detail.

In a preferred embodiment of the present invention, data transfer between the audio processor 100 and an external secure memory is carried via the SMC 106. The internal units of the audio processor 100 may transfer data, preferably simultaneously, to and from the SMC 106, preferably using request commands to deal with in/out FIFO buffers (not shown) and direct memory access modules. For example, data transfers can be done in order to store an encoded audio bit-stream in an external memory, read an audio bit-stream from an external memory for decoding, and read/write pages of data/instructions to/from the data caches 505 and instruction caches comprised in the MCU 107. Preferably, the data transfer request commands can be issued simultaneously. The SMC 106 manages a queue of data requests and memory accesses, and a queue of priorities assigned to each access request, manages memory communication protocol, automatically allocates memory space and bandwidth, and comprises hardware dedicated to providing priority and quality of service.

Preferably, the SMC 106 is a secure SMC, designed to encrypt and decrypt data in accordance to a variety of encryption schemes. Each memory address can have a different secret key assigned to it. The secret keys are preferably changeable, and can change based, at least partly, on information from such sources as, for example: information kept in a secure One Time Programmable (OTP) memory which may be included into MCU 107; information received from external security devices such as Smartcards connected via the Host/Switch interface 108; information received from an on-chip true random number generator; and so on.

In yet another preferred embodiment of the invention, the SMC 106 can take the form of a socket of, and connect to a secured memory controller such as described in U.S. patent application Ser. No. 11/603,199 of Morad et al.

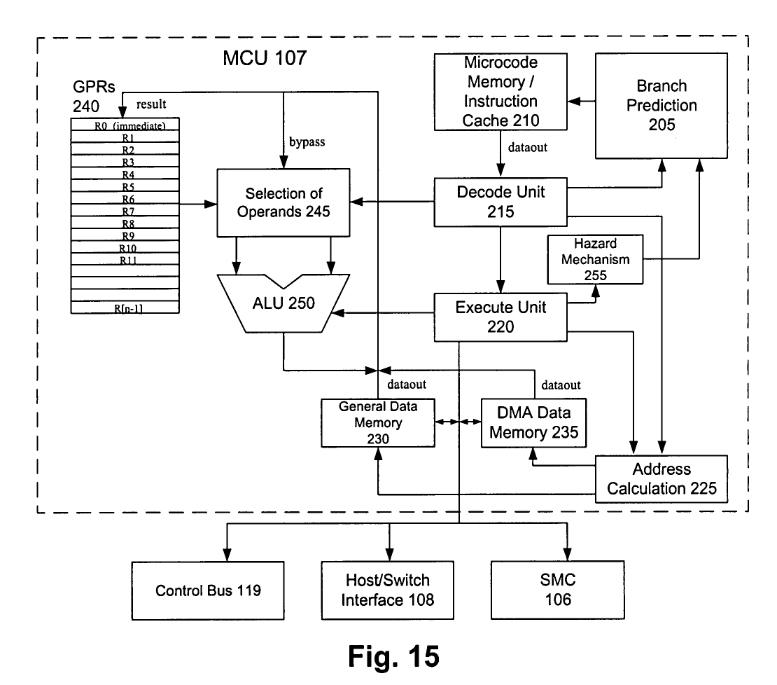

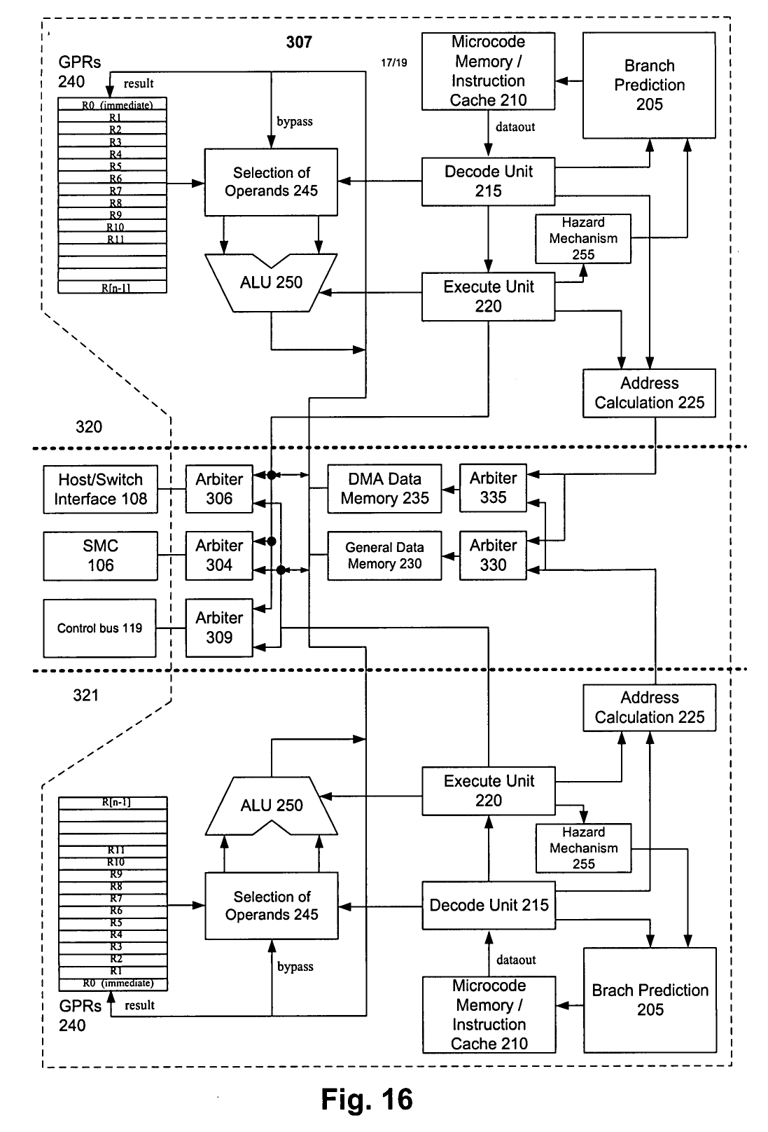

It is to be appreciated that the audio processor 100 comprises separate encoding/multiplexing and decoding/de-multiplexing data flows. The MCU 107 is operatively connected to both the encoding/multiplexing data flow and the decoding/de-multiplexing data flow. The MCU 107 as described below, and described additionally with respect to FIG. 15 and FIG. 16, enables the audio processor 100 to perform simultaneous encoding/multiplexing and decoding/de-multiplexing, and decode/de-multiplex more than one input stream and encode/multiplex more than one output stream simultaneously.

In a preferred embodiment of the present invention, the audio processor 100 is integrated on a single integrated circuit.

Reference is now made to FIG. 15, which is a simplified functional diagram of the Micro Controller Unit (MCU) 107 of the audio processor 100 of FIG. 1A.

In a preferred embodiment of the present invention, the MCU 107 processor is constructed with a unique Reduced Instruction Set Computer (RISC) architecture which comprises hardware based instructions as described below, some of which are additionally supported by hardware based accelerators.

The MCU 107 preferably comprises the following instruction set:

TABLE 1
MCU 107 opcodes

| OPCODE OR | |
|---|---|
| OPCODE GROUP | DESCRIPTION OF OPCODE AND COMMENTS |
| Load dedicated | Load a value from a dedicated mux/demux register |
| | (described in more detail below, with reference to FIGS. 15-16). |
| Store dedicated | Store a value into a dedicated mux/demux register. |
| Add | Add contents of 2 general purpose registers (GPRs). Uses |
| | the following flags: use carry, use saturation, shift right 1 bit. |
| Subtract | Subtract contents of 2 GPRs. Uses the following flags: use |
| | carry, use saturation, shift right 1 bit. |
| Logic operations | A group of opcodes for performing logic operations on |
| | contents of one or two GPRs (depending on the logic |
| | operation). The logic operations are: AND, OR, |
| | FIND_MSB, XOR, SHIFT_RIGHT, SHIFT_LEFT. |
| Arithmetic operations | A group of opcodes for performing arithmetic operations on |
| | contents of a GPR. The arithmetic operations are: |
| | SHIFT_RIGHT, ABS, MABS, MIN, MAX. |
| Insert | Insert a value from GPR into a specified location in another |
| | GPR. |
| Extract | Extract a value from a specified location of one GPR into |
| | another GPR. |
| Multiply | Multiply contents of two GPRs. Typically produces a |
| | 64-bit result. If each GPR is 32-bits, the 64-bit result is |
| | stored in two GPRs. |
| Load immediate | Load an immediate field into a GPR. An immediate field is |
| | a field in an instruction which comprises data, and not an |
| | address of where the data resides. |
| Load 4 bytes | Load one 32-bit word from general data memory. |
| | Options: the address of the word can come from a GPR, |
| | from an immediate field, and via an indirect pointer. |
| Store 4 bytes | Store one 32-bit word in general data memory. |
| | Options: the address of the word can come from a GPR, |
| | from an immediate field, and via an indirect pointer. |
| Load 8 bytes | Load one 64-bit word from DMA data memory. |
| | Options: the address of the word can come from a GPR, |
| | from an immediate field, and via an indirect pointer. |
| Store 8 bytes | Store one 64-bit word in DMA data memory. |
| | Options: the address of the word can come from a GPR, |
| | from an immediate field, and via an indirect pointer. |
| Branch | Compare contents of two GPRs. If a specified condition is |
| | satisfied, change a program counter (not shown) to point to |
| | a jump address. |
| | Conditions which may be specified: equal, not equal, less |
| | than, less than or equal, greater than, greater than or equal. |
| Call | Call a routine. The program counter (not shown) is saved in |
| | a multi-level stack. |
| Return | Return from a routine. The program counter (not shown) is |
| | restored from the multi-level stack. |
| Interface activation | A group of opcodes that may: |
| | activate a DMA interface and issue a request to the SMC |
| | 106; |
| | activate the Host/Switch interface 108 and issue a single |
| | request as master to Host/Switch Input/output 123; and |
| | activate the Host/Switch interface 108 and issue a pipe |
| | request as master to Host/Switch Input/output 123. |
| Divider activation | Activate the multi-cycle divider to perform long division |
| | using data from three GPRs and store a result in a fourth |
| | GPR. The division nominator is a concatenation of values |
| | in two of the three GPRs, providing double precision, and |
| | the division denominator is a value of the third GPR. |
| Nop | No operation. |

To maximize performance of the MCU 107, each instruction comprises a field for prediction of a next address to be read from an instruction cache, thereby enabling software branch prediction. The MCU 107 comprises a branch prediction unit 205, to perform the software branch prediction.

In preferred embodiment of the invention, MCU 107 comprises a microcode memory and instruction cache 210.

Caching instructions, in addition to improving performance and reducing hardware cost, removes limitations on microcode size, in order, by way of a non-limiting example, to support multi-standard audio multiplexing/encoding/decoding/de-multiplexing which may require a lengthy code space.

Caching data, in addition to improving performance and reducing hardware cost, removes limitations on an amount of data that the audio processor 100 is able to store, by way of a non-limiting example, to support multi-standard audio multiplexing/encoding/decoding/de-multiplexing which may require a large data storage space.

The microcode memory and instruction cache 210 preferably has a 32 bit word width. A physical address space and a virtual address space of the microcode memory and instruction cache 210, as well as associativity, are pre-determined according to a specific implementation. The virtual address space is mapped to an external memory, such as, for example, DDR memory via the SMC 106, by dedicated registers which can be configured by the MCU 107.

When the microcode memory and instruction cache 210 receives a read or a write request, the microcode memory and instruction cache 210 checks whether it has an appropriate page containing the requested address in its physical address space. If the page is in the physical address space, the cache module returns an acknowledgement to the MCU 107 on a following cycle, and in case of a read instruction, together with the data.

If the page needs to be brought from the external memory, a read request is issued to the SMC 106, with a translation of the virtual address into a corresponding external memory address, and a timeout which comes from a pre-configured dedicated register. Only when the SMC 106 returns the data of the entire page to the physical space, will the acknowledge signal be raised, together with the data in case of a read instruction.

A page replacement policy is preferably Least Recently Fetched, that is, when a new block requires space in the microcode memory and instruction cache 210, an oldest block which was brought into the microcode memory and instruction cache 210 is thrown. The MCU 107 uses a hazard mechanism to prevent new load/store cache instructions, by halting pipeline instructions if such an instruction occurs before the acknowledge signal is raised.

The MCU 107 is a pipelined processor, having at least three processing stages. By way of a non-limiting example, the three processing stages are: fetch, decode, and execute.

Preferably, in each MCU 107 computing cycle, the branch prediction unit 205 provides an address of a next instruction to the microcode memory and instruction cache 210. Usually, the next instruction can be located in the microcode memory and instruction cache 210. If the next instruction is not in the microcode memory and instruction cache 210, the next instruction is fetched via the SMC 106 from an external microcode storage memory (not shown). It is to be appreciated that typically, the microcode is preloaded into the microcode memory and instruction cache 210 before the audio processor 100 starts its operation.

The MCU 107 processes a next instruction in accordance with the three stages, which are further described below.

In the fetch stage, the instruction that was fetched from the external microcode memory (not shown) to the microcode memory and instruction cache 210 is parsed, fields comprised in the instruction are extracted, and written into pipe registers (not shown) to be passed to the decode unit 215.

The operation of the decode stage will now be described.

An MCU 107 instruction typically comprises a field or fields containing IDs of General Purpose Registers (GPRs). The GPRs comprise source GPRs with values of operands, and destination GPRs, for storing a result of executing the instruction. The decode unit 215 reads each field, preferably decodes the field, and stores values from the operand GPRs into pipe registers (not shown), to be passed to the execute stage.

By way of a non-limiting example, each instruction has 4 bits of operation code (opcode), one to four GPR ID fields, immediate operand fields, and flag fields. The GPR ID fields indicate the source GPRs and the destination GPRs. The length of each field in the instruction is preferably flexible, according to field lengths required by different instructions. By way of a non-limiting example, each of the GPR ID fields is 4 bits long.

The decode unit tentatively executes the instruction, preferably providing a result of executing the instruction no later than at a beginning of the execute stage. Computations involving multi-cycle instructions, such as, by way of a non-limiting example, multiply and load instructions, are thereby started at the decode stage.

If an instruction for loading data from memory is decoded by the decode unit 215, an address from which the load is to be performed is calculated by an address calculation unit 225, and a read-from-memory signal is raised. The address calculation unit 225 is operatively connected to two memories, a general data memory 230, and a Direct Memory Access (DMA) data memory 235. An appropriate one of the data memories returns data on the next cycle, when the instruction is at the execute stage. The data is then loaded from memory and written into an appropriate GPR in a GPR file 240.

There are preferably two types of memory in the MCU 107. One type of memory is the general data memory 230, used for storing temporary variables and data structures, and a second type of memory is the DMA data memory 235, used for storing data arriving from, and intended for transfer to, the SMC 106.

Values from appropriate source GPRs are also supplied, via a selection of operands unit 245, as inputs to a two-stage multiplier in an ALU 250, for use in case of a multiply instruction. In case of a multiply instruction, a result for output will be ready on a following cycle, when the instruction is at the execute stage.

The number of registers in the GPR file 240 comprises, by way of a non-limiting example, 16 GPRs, enumerating R0 to R15, each of the GPRs comprising, by way of a non-limiting example 32 bits. The GPRs are used for temporary data storage during instruction execution.

In case of a branch instruction, a call instruction, and a return instruction, the decode unit 215 loads appropriate operands using the selection of operands unit 245. The selection of operands unit 245 operates as follows.

The selection of operands unit 245 comprises multiplexers controlled by the operand fields in an instruction. The ALU 250 performs a comparison. If a condition specified in the comparison is satisfied, a microcode memory address is replaced with an appropriate jump address according to the instruction. Otherwise, the microcode memory address is simply increased by 1. Operation of the comparison instructions ends at the decode stage, and does not affect other logic or other registers during the execute stage.

The operation of the execute stage will now be described.

Data retrieved and stored during the decode stage is used for performing logic and arithmetic operations in the ALU 250. The actual operation of the execute stage depends on an opcode in a current instruction.

If an opcode is an add opcode, a subtract opcode, a logic operation opcode, an insert opcode, an extract opcode, a multiply opcode, or a load immediate opcode, the output of the ALU 250 is stored into a destination GPR which is specified in the instruction comprising the opcode.

If an opcode is load 4 bytes, or load 8 bytes, data from data memories which are specified in fields in the instruction comprising the opcode is stored into a destination register also specified in the instruction.

If an opcode is store 4 bytes, or store 8 bytes, an address, data, and a write request signal are issued to a data memory as specified by the address.

If an opcode is an interface activation, then a request is issued to one of the interfaces SMC 106 and Host/Switch interface 108.

If an opcode is a divide activation, then a request comprising source and destination GPR addresses is issued to a hardware divider.

In a preferred embodiment of the present invention, the architecture of the processor includes a hardware hazard mechanism 255 and a hardware bypass mechanism (not shown).

The hazard mechanism 255 is designed to resolve data contention when one of the following instructions: multiply, load, branch, call, and return, uses a GPR at the decode stage, while at the same time another instruction which is at the execute stage modifies content of the same GPR. The hazard mechanism continuously compares a destination field, or destination fields, of a current execute stage instruction to a source field or source fields of a current decode stage instruction. If there is a match, that is, one or more of the execute stage destination fields coincides with one or more of the decode stage source fields, a hardware bubble is inserted between the decode stage instruction and the execute stage instruction. The hardware bubble is a NOP instruction, inserted automatically by the hazard mechanism 255. The decode stage instruction will thus be held for one more cycle in the decode stage, while the execute stage instruction is performed. This operation is similar to a regular NOP, but is performed automatically by the hazard mechanism 255. The operation affects the MCU 107 performance, but doesn't occupy space in microcode memory.

The hardware bypass mechanism (not shown) is designed to resolve data contention when an instruction at the decode stage is not one of the following instructions: multiply, load, branch, call or return. In this case, a hazard does not occur. However, during the decode stage, source fields are translated into GPR contents, for the contents to be modified later, at the execute stage. In such cases, a result of a current execute stage, stored into a GPR, may collide with decode stage data. The bypass mechanism continuously compares destination fields of the execute stage instruction to source fields of the decode stage instruction. If one or more of the execute destination fields coincides with one or more of the decode source fields, the decode unit 215 discards the content of the decode source field and uses the result of the current execute stage. Since many instructions depend on results of previous instructions, an alternative to the bypass mechanism would be a inserting a NOP instruction. The bypass mechanism prevents such “dead” cycles and significantly improves performance of the MCU 107.

The MCU 107 unit deals automatically, using hardware, with stream and sample alignment, and with cases such as when a bit-stream buffer is empty and full. The bit-stream buffer can be, by way of a non-limiting example, the input FIFO buffers 105 (FIG. 1B), the output FIFO buffer 109 (FIG. 1B), and an external memory interfaced via the SMC 106. One or more dedicated mux/demux registers (not shown) are connected to the execute stage 220, and to the control bus 119 (FIG. 1B), in order to ensure stream alignment, and resolve cases such as bit-stream buffer empty and bit-stream buffer full. The dedicated mux/demux registers (not shown) comprise pointer registers, which point to a next position from which data is to be read from a bit-stream buffer, and to a next position to which data is to be written in the bit-stream buffer. The dedicated mux/demux registers (not shown) are configured so that whenever the bit-stream buffer is empty or full, a request is issued to the SMC 106 for reading or writing data via the memory interface 122 (FIG. 1B).

The use of the one or more dedicated mux/demux registers (not shown) in ensuring stream alignment will be additionally described below with reference to unique instructions, named put-bits and get-bits, which are preferably implemented in the MCU 107 instruction set.

In preferred embodiments of the present invention, the MCU 107 includes one or more hardware accelerator units as described below.

In a preferred embodiment of the present invention, microcode memory as typically used in standard microprocessors is replaced by the microcode memory and instruction cache 210. The microcode memory and instruction cache 210 is preferably 64 bits wide, thus enabling storage of long programs. The virtual space of the cache is mapped into an area of an external memory. In such an embodiment, address selection in branch instructions is made during the decode stage, and is sampled and issued to the microcode memory and instruction cache 210 only at the execute stage.

In another preferred embodiment of the present invention, in addition to the general data memory 230 and the DMA data memory 235, one or more additional data caches (not shown) are implemented for storage of larger data arrays and buffers. The one or more data caches are preferably 32 bits wide. For accessing the one or more additional data caches, an additional specific instruction is implemented. The opcode of such instruction is load/store data cache. An address for the data cache is calculated during the decode stage and passed to the execute stage. Both load and store instructions issue the stored address during the execute stage. The three stages in a pipeline described above with respect to FIG. 15, fetch, decode, and execute, are preferably extended to have one extra stage, since the additional specific instruction uses an additional execute stage for receiving data from the additional data caches (not shown) and sampling the data into an appropriate GPR.

In another preferred embodiment of the present invention, the MCU 107 comprises one or more additional load/store instructions for accessing other data memories (not shown), in addition to the general data memory 230 and the DMA data memory 235. The additional load/store instructions operate similarly to the load/store 4/8 byte instructions.

In yet another preferred embodiment of the present invention, described in more detail below with reference to FIG. 16, the MCU is enhanced by implementing support for multi-instruction, preferably dual instruction, acceleration. The support enables multi-consecutive independent instructions to be united into a single instruction during compilation. The ALU 250 is duplicated, so that multiple arithmetic and logic instructions can be carried out simultaneously. The general data memory 230 and the DMA data memory 235 are split into banks, so that, preferably, two load and store instructions can simultaneously access memory at two different addresses, each of the two different addresses belonging to a different bank. The hazard and bypass mechanisms are preferably extended so that all possible dependencies are checked. In the following example, four options need to be checked in order to prevent contention in performing two simultaneous instructions:
1. Comparison of decode stage instruction source fields of a first instruction with execute stage instruction destination fields of the first instruction.
2. Comparison of the decode stage instruction source fields of the first instruction with the execute stage instruction destination fields of a second instruction.
3. Comparison of the decode stage instruction source fields of the second instruction with the execute stage instruction destination fields of the first instruction.
4. Comparison of decode stage instruction source fields of the second instruction with the execute stage instruction destination fields of the second instruction.

In another preferred embodiment of the present invention, the MCU 107 comprises several processors with shared resources. Persons skilled in the art will appreciate that in such an embodiment, the MCU 107 is a super-scalar multi-processor.

Reference is now made to FIG. 16 which is a simplified functional diagram of an alternative embodiment of an MCU 307 in the audio processor 100 of FIG. 1A. The MCU 307 is constructed according to a multi-processor architecture.

By way of a non-limiting example, the MCU 307 comprises two processors, preferably integrated in a single integrated circuit.

A first processor preferably comprises components similar to components described with reference to FIG. 15, which are similarly operatively connected. The components are a branch prediction 205 unit, a microcode memory and instruction cache 210, a decode unit 215, an execute unit 220, an address calculation unit 225, a GPR file 240, a selection of operands unit 245, an ALU 250, and a hazard mechanism 255. The components of the first processor are depicted above dashed line 320 of FIG. 16.

A second processor preferably comprises components similar to components described with reference to FIG. 15, which are similarly operatively connected. The components are a branch prediction 205 unit, a microcode memory and instruction cache 210, a decode unit 215, an execute unit 220, an address calculation unit 225, a GPR file 240, a selection of operands unit 245, an ALU 250, and a hazard mechanism 255. The components of the second processor are depicted below dashed line 321 of FIG. 16.

The first processor and the second processor share a general data memory 230, a DMA data memory 235, a SMC 106, a Host/Switch interface 108, and a control bus 119.

In order to share the general data memory 230, an arbiter 330 is placed at an input of the general data memory 230, for handling cases of simultaneous requests to the general data memory 230.

In order to share the DMA data memory 235, an arbiter 335 is placed at an input of the DMA data memory 235, for handling cases of simultaneous requests to the DMA data memory 235.

In order to share the SMC 106, an arbiter 304 is placed at an input of the SMC 106, for handling cases of simultaneous requests to the SMC 106.

In order to share the Host/Switch interface 108, an arbiter 306 is placed at an input of the Host/Switch interface 108, for handling cases of simultaneous requests to the Host/Switch interface 108.

In order to share the control bus 119, an arbiter 309 is placed at an input of the control bus 119, for handling cases of simultaneous requests to the control bus 119.

It is to be appreciated that the arbiters 304, 306, 309, 330, 335 typically perform as follows: if there is no contention, the arbiters 304, 306, 309, 330, 335 forward requests and commands to input of units for which the arbiters 304, 306, 309, 330, 335 perform arbitration. If there is contention, caused by two requests or commands arriving at a unit simultaneously, or by a request or a command arriving while the unit is busy, the arbiters return a signal to the MCU which needs to wait, and the MCU uses the hardware hazard mechanism 255. The hazard mechanism 255 blocks execution of an instruction in the MCU which needs to wait, for one cycle, after which the MCU re-sends the request or command, repeating the above until the MCU succeeds.

The processors within the MCU 307 communicate and synchronize their operations using various synchronization techniques such as semaphores and special flag registers. Since each processor has an independent microcode memory and instruction cache 210, ALU 250, and GPR file 240, the number of instructions carried out simultaneously can equal the number of processors. The multi-processor architecture is used when performance requirements can not be satisfied by a single processor.

Additional enhancements to the present invention are described below.

In a preferred embodiment of the present invention, several narrow registers, by way of a non-limiting example, 8-bit wide registers, can be dynamically configured into one larger register. By way of a non-limiting example, nine 8-bit registers can be dynamically configured into one long 72 bit accumulator.

In a preferred embodiment of the present invention, one or more automatic step registers (not shown) are implemented, designed to automatically increase/decrease step values stored in a GPR used in load/store/branch operations. Preferably several, by way of a non-limiting example two, step values are concatenated and stored in each of the step registers. Operation of a step register mechanism is illustrated by the following non-limiting example. Given a microcode loop containing a load instruction, the load instruction uses a GPR as a pointer to memory, that is, the GPR contains a memory address. The memory address is to be incremented at each iteration of the microcode loop by a given value. The step register mechanism configures an automatic step register so that each time the load instruction occurs, the GPR containing the memory address is incremented by the given value. The automatic step register mechanism removes a need for explicit calculation of a next address in microcode, and significantly improves performance of the MCU 107.

It is to be appreciated that features described with reference to the MCU 107 throughout the present specification are to be understood as referring also to the MCU 307.

In preferred embodiments of the present invention, additional instructions are implemented to further improve the MCU 107 performance. Depending on an intended use for an implementation of the present invention, one of the additional instructions, or several of the additional instruction in combination may be provided in the implementation. The additional instructions are:

A multiply-and-accumulate instruction: a multi-cycle instruction, which multiplies contents of 2 GPRs, and accumulates a result of the multiplication in an accumulator. By way of a non-limiting example, the multiply-and-accumulate instruction multiplies contents stored in two 64-bit GPRs and stores a result in a 72-bit accumulator. To support the multiply-and-accumulate instruction, the fetch, decode, and execute stages are extended by adding a pre-decode stage and a second execute stage, in order to improve efficiency. Hazard and bypass mechanisms are extended to address possible data contentions between the new stages.

A concatenate-and-accumulate instruction: a single cycle instruction, which concatenates contents of 2 GPRs, and accumulates the concatenated result in an accumulator. By way of a non-limiting example, the concatenate-and-accumulate instruction concatenates contents of two 32-bit GPRs into a 64-bit result, and accumulates the result in a 72-bit accumulator.

A bit-reverse instruction: a single cycle instruction, which reverses a bit order of, by a way of non-limiting example, the lowest N bits of a first GPR, and stores a result in a second GPR. It is to be appreciated that the value of N may be delivered through an immediate operand field, or by a third GPR. It is also to be appreciated that the first GPR and the second GPR can be the same, thereby performing in-place bit-reversal.

A multiply-and-shift instruction: a multi-cycle instruction, which multiplies contents of 2 GPRs, shifts the result, by a way of non-limiting example, right by a number of bits specified in another GPR, and stores the lowest M bits, by way of a non-limiting example, the lowest 32 bits, of the right-shifted result in a GPR.

A put-bits instruction and a get-bits instruction: preferably single cycle instructions.

The put-bits instruction puts P bits from a GPR to a bit-stream buffer. The get-bits instruction gets P bits from a bit-stream buffer to a GPR. The bit-stream buffer may be, by way of a non-limiting example, in external memory accessed via the memory interface 121 of FIG. 1B, the input FIFO buffer 103 of FIG. 1B, and the output FIFO buffer 107 of FIG. 1B. The dedicated mux/demux registers 260 comprise pointer registers, which advance whenever data is written into and read from the bit-stream buffer. The pointer registers always points to a next position to be written into and read from in the bit-stream buffer. The register pointers are incremented by a value of P in performing each put-bits and get-bits instruction, P being typically comprised in an immediate field in the put-bits and get-bits instructions. Maintaining the pointer registers ensures correct stream alignment for read and write operations.

There are 3 possible get-bits instructions, left justified get-bits with sign extension, left justified get-bits without sign extension, and right justified get-bits.

Left justified get-bits with sign extension aligns sign extended P bits read from a bit-stream buffer to a bit n configured by the microcode. Left justified get-bits without sign extension aligns the P bits read from the bit-stream buffer to the bit n configured by the microcode. Right justified get-bits aligns the P bits read from the bit-stream buffer to the right. For example, for P=8 and n=16, and when the 8 bits to be read from the bit-stream buffer are OXED, each of the 3 get-bit instructions would store in a 32 bits GPR, for example r1, the following result:
Left justified get-bits with sign extension would store: r1=0xFFFFED00.
Left justified get-bits without sign extension would store: r1=0x0000ED00.
Right justified get-bits would store: r1=0x000000ED.

The MCU 107 selects which get-bits instruction will be performed by using dedicated bits in the get-bits instruction field.

A branch Host/Switch instruction: an instruction that behaves similarly to a regular branch instruction, but instead of comparing values stored in GPRs, compares a value of a register obtained via the Host/Switch interface 108 with an immediate value, and updates a jump address if the comparison condition is satisfied. The register whose value was obtained via the Host/Switch interface 108 is one of the dedicated registers.

A cyclic-left-shift instruction: a single cycle instruction which performs a cyclic left shift on contents of a GPR, and stores the result in a GPR. Such a shift may be a cyclic shift of an entire data word, or a cyclic shift of N bits of a K-th group of bits, by way of a non-limiting example cyclic-left-shifting eight bits of each byte of a value stored in the GPR.

A median instruction: a single cycle instruction which returns a median value of contents of several, by way of a non-limiting example three, GPRs, and stores a result in a GPR. It is to be appreciated that the median instruction comprises a field for each GPR with a value for which the median value is to be calculated, and a field for a GPR where the result is to be stored.

A controller instruction: a single cycle instruction designed to control special purpose hardware units. The parameters and control signals may be included in immediate fields of the instruction.

A swap instruction: a single cycle instruction which swaps locations of groups of bits, by way of a non-limiting example, swapping bytes, which are groups of 8 bits, of a GPR, and stores a result in a GPR. By way of a non-limiting example, the swap instruction can be used to swap bytes 3, 2, 1, 0 and store as bytes 0, 1, 2, 3. The swap order can be defined by a value in an immediate field, and the swap order can be defined by an address of a GPR which contains the value defining the swap order.

A load-filter-store instruction: an instruction designed to speed-up linear filtering, by way of a non-limiting example, convolution operations. The load-filter-store instruction is a pipeline instruction in which every clock cycle essentially performs three different operations, as follows: (1) simultaneously loads more than one data word from several different memories, (2) performs a filtering operation on data words loaded in a previous cycle, and (3) stores results of the filtering operation performed in the previous cycle into memory. By way of a non-limiting example, the load-filter-store instruction simultaneously loads two data words and two filter coefficients from two different memories, performs a filtering operation on two data words which were loaded in a previous cycle, and stores two filtered data words, which are results of the filtering operation performed in the previous cycle, into two different memories. It is to be appreciated that once the load-filter-store pipeline is full, after, by the way of a non-limiting example, two clock cycles, the operation inputs and outputs data once per computing cycle, thereby providing a throughput substantially similar to the throughput of a one cycle instruction.

A clip-N-K instruction: a single cycle instruction which clips a value comprised in certain bits of a GPR into a range of values from N through K, and stores a result in a GPR. By way of a non-limiting example, the clip-N-K instruction clips the value of a GPR into a range between 30 and 334.

An instruction for parallel zeroing of multiple dedicated registers: by using a single Store Dedicated instruction, several dedicated registers are reset to a value of zero in one cycle. The registers can be chosen by configuring, that is, setting a value, to a dedicated register.

It is to be appreciated that the MCU 107 can also operate as a general purpose stand-alone processor, and as such, can run an operating system such as Linux, can have its own compiler, and so on.

### An Encoding Path

In a preferred embodiment of the present invention, the audio processor 100 is operated in an encoding mode, in which the analog and digital data filters 103 104 (FIG. 1B) receive a number of audio and data signals from the AFE 101 (FIG. 1B), the DFE 102 (FIG. 1B), the SMC 106, such as, for example, a previously stored uncompressed audio stream, and from the Host/Switch interface 108 (FIG. 1B). Following pre-processing by the analog and digital data filters 103 104 (FIG. 1B), the audio and data signals are transferred to the MCU 107, which compresses the audio and data signals using a set of encoding standards, multiplexes the audio and data packets, for example, producing a program or a transport stream, and preferably encrypts the produced stream. Preferably, the transport stream is indexed in a manner which allows implementation of trick plays, such as fast forward, fast backward, and so on. Following the indexing, the encrypted multiplexed streams are transmitted through the output digital audio output 125, or transferred to an external peripheral through the Host/Switch interface 108, or transferred to the SMC 106.

### A Decoding Path

In a preferred embodiment of the present invention, the audio processor 100 is operated in decoding mode, in which the MCU 107 receives a number of encoded audio and data packets from the AFE 101 (FIG. 1B), the DFE 102 (FIG. 1B), the SMC 106, such as, for example, a previously stored compressed audio stream, and from the Host/Switch interface 108. The MCU 107 de-multiplexes the audio/data packets, for example, de-multiplexing a program or transport stream, and preferably decrypts the audio/data packets. The MCU 107 then uncompresses the audio/data packets using a set of decoding standards. Preferably, the transport stream is indexed in a manner that allows implementation of trick plays, such as fast forward, fast backward, and so on. Following the indexing, the uncompressed streams are played back by using the output FIFO buffers 109 and the ABE 110 and/or the DBE 111, or by transferring to an external peripheral through the Host/Switch interface 108, or to the SMC 106.

### A Transcoder Path

In a preferred embodiment of the present invention, the audio processor 100 operates in transcoding mode. In transcoding mode, several streams are acquired and decoded following the decoder path described above. The streams are preferably further encoded following the encoder path described above. The encoded streams are further transmitted or stored in the manner described above.

### Application

A non-limiting practical application of the audio processor 100 is in conjunction with a media codec device, such as described in U.S. patent application Ser. No. 11/603,199 of Morad et al.

### General Use

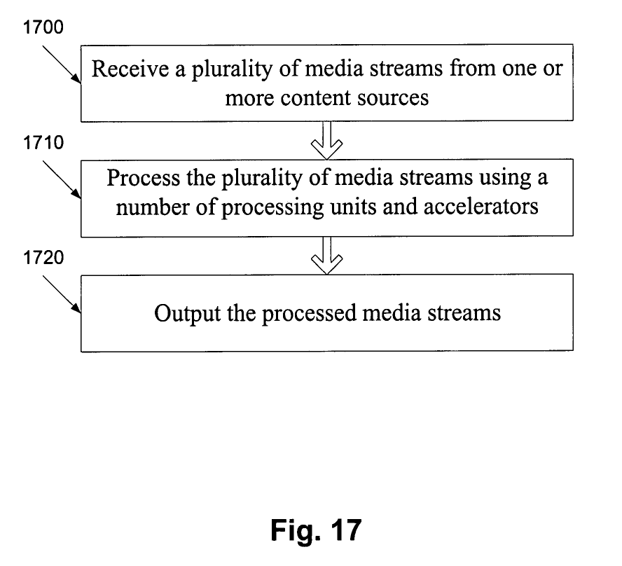

Reference is now made to FIG. 17, which is a simplified flowchart of a method of processing media streams by the audio processor 100 of FIG. 1A.

During a first step, as shown at step 1700, one or more analog or digital media streams, which are either compressed or uncompressed, are received from one or more content sources. The data streams are preferably received at a STB which comprises the audio processor 100 (FIG. 1A) or at a CE appliance that is connected to such a STB, such as a HD-DVD, a Blu-Ray player, a personal video recorder, a place-shifting TV, and a digital TV.

The audio processor 100 (FIG. 1A) allows execution of one or more of the following operations in parallel, on one or more of the received media streams, as shown at step 1710:
(a) Decrypting, indexing, de-multiplexing, decoding, post-processing;
(b) Preprocessing, encoding, multiplexing, indexing and encrypting;
(c) Transcoding the media data streams; and
(d) Executing a plurality of other real-time system tasks;

As shown at step 1720, the processed media streams, which are now either compressed or uncompressed, and are represented in digital or analog form, are output to storage, to transmission, or to a sound device. Such architecture allows a number of storage, transmission, and display devices to receive processed media stream or derivative thereof, and allows a number of users to simultaneously access different media channels.

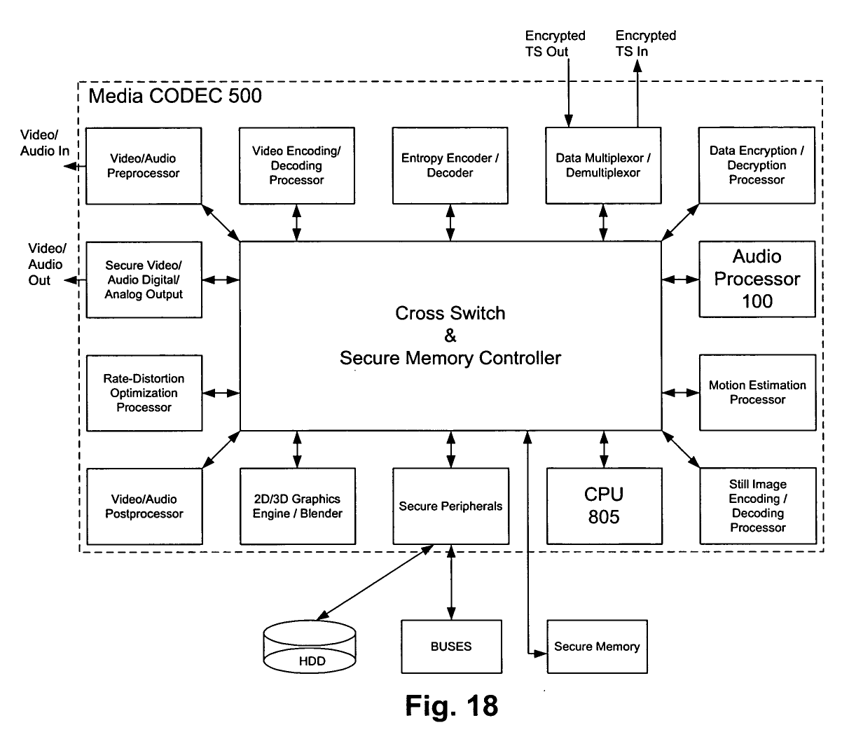

Reference is now made to FIG. 18, which is a simplified block diagram of a non-limiting example of a practical use for the audio processor 100 of FIG. 1A.

FIG. 18 depicts the audio processor 100 of FIG. 1A in context of a media codec device 500. The media codec device 500 is described in U.S. patent application Ser. No. 11/603,199 of Morad et al.

The media codec device 500 receives video, audio, and data streams and performs one or more of the following sequences of actions:

de-multiplexes, decrypts, and decodes received data streams in accordance with one or more algorithms, and indexes, post-processes, blends and plays back the received data streams;

pre-processes, encodes in accordance with one or more compression algorithms, multiplexes, indexes, and encrypts a plurality of video, audio and data streams;

trans-codes, in accordance with one or more compression algorithms, a plurality of video, audio, and data streams, to a plurality of video, audio and data streams;

performs a plurality of real-time operating system tasks, via an embedded CPU 805; and

performs a combination of the above.

It is expected that during the life of this patent many relevant devices and systems will be developed and the scope of the terms herein, particularly of the terms FIR accelerator, IIR accelerator, logarithmic accelerator, polynomial accelerator, add-dB accelerator, and SQRT accelerator, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Apparatus for processing audio signal streams comprising:
a plurality of audio signal inputs;
an audio signal output;
a Micro Controller Unit (MCU); and
a plurality of audio signal processing units, and
wherein the audio signal input, the audio signal output, and the plurality of audio signal processing units are connected to and programmably controlled by the MCU, and wherein the audio signal processing units are configured to process more than one audio signal stream at the same time.

2. The apparatus according to claim 1 and wherein the plurality of audio signal inputs comprise both analog and digital audio signal inputs, and the audio signal processing units are configured to process both analog and digital audio signals.

3. The apparatus according to claim 1 and wherein the plurality of audio signal inputs comprise audio signal inputs encoded according to more than one standard, and the audio signal processing units are programmably configured to process audio signals encoded according to more than one standard.

4. The apparatus according to claim 1 and wherein the plurality of audio signal inputs comprises compressed digital audio signal inputs, and the audio signal processing units are programmably configured to process the compressed digital audio signals.

5. The apparatus according to claim 1 and wherein the plurality of audio signal inputs comprises watermarked audio signal inputs, and the audio signal processing units are programmably configured to process the watermarked audio signal inputs.

6. The apparatus according to claim 1 and wherein the audio signal output comprises a plurality of audio signal outputs.

7. The apparatus according to claim 1 and wherein at least some of the audio signal processing units are configured to produce a digital audio signal output, and the audio signal output is programmably configured to output a digital audio signal output.

8. The apparatus according to claim 1 and wherein at least some of the audio signal processing units are configured to produce a digital audio signal output according to more than one standard, and the audio signal output is programmably configured to output a digital audio signal output according to more than one standard.

9. The apparatus according to claim 1 and wherein at least some of the audio signal processing units are configured to produce a compressed digital audio signal output, and the audio signal output is programmably configured to output a compressed digital audio signal output.

10. The apparatus according to claim 1 and wherein at least some of the audio signal processing units are configured to produce a watermarked audio signal output, and the audio signal output is programmably configured to output a watermarked audio signal output.

11. The apparatus according to claim 1 and wherein the audio signal processing units comprise a Finite Impulse Response (FIR) processing unit.

12. The apparatus according to claim 1 and wherein the audio signal processing units comprise an Infinite Impulse Response (IIR) processing unit.

13. The apparatus according to claim 1 and wherein the audio signal processing units comprise a processing unit programmably configured to perform polynomial calculations with audio samples.

14. The apparatus according to claim 1 and wherein the audio signal processing units comprise a processing unit configured to perform logarithmic calculations with audio samples.

15. The apparatus according to claim 1 and wherein the audio signal processing units comprise a processing unit configured to accelerate computing a result of two inputs, x and y, as follows: result=10·log₁₀(10^{x/10}+10^{y/10}).

16. The apparatus according to claim 1 and wherein the audio signal processing units comprise a processing unit configured to accelerate calculations of a square root of an audio sample.

17. The apparatus according to claim 1 and further comprising input and output buffers, and wherein the input and output buffers are connected to at least one of the audio signal processing units by Direct Memory Access (DMA).

18. The apparatus according to claim 1 and wherein the MCU comprises a multi-processor MCU.

19. The apparatus according to claim 1 and wherein the MCU is configured to perform at least one of the following as a single instruction:
a concatenate-and-accumulate instruction comprising concatenating a value stored in a first general purpose register (GPR) to a value stored in a second GPR, and adding a result of the concatenating to a value in an accumulator;
a bit-reverse instruction comprising reversing a bit order of a lower N bits of a value stored in a first GPR and storing a result of the bit-reverse instruction in a second GPR;
a get-bits instruction comprising reading an M bit value from an address in a buffer external to the microcontroller, the address being comprised in the get-bits instruction, and storing the M bit value in a GPR;
a put-bits instruction comprising reading an M bit value from a GPR, and writing the M bit value in an address in a buffer external to the microcontroller, the address being comprised in the put-bits instruction;
a median instruction comprising computing a median value of more than one general purpose register, and storing the median value in a general purpose register;
a controller instruction for controlling dedicated hardware units external to the microcontroller, the address of which, and the digital control signals to be sent, are included in fields comprised in the controller instruction;
a swap instruction for swapping locations of a number of bits of a general purpose register and storing the result in a general purpose register;
a load-filter-store instruction for loading more than one value from more than one different memory addresses, performing a linear filtering operation, and storing more than one result into more than one different memory addresses;
a clip-N-K instruction for clipping a value comprised in specific bits in a general purpose register into a range of integers from N through K, where N and K are integers, and storing a result of the clipping in a general purpose register; and
a compare-PID instruction for simultaneously comparing a value to more than one other values.

20. The microcontroller according to claim 19 and wherein the value of N in the bit-reverse instruction is comprised in an immediate field in the bit-reverse instruction.

21. The microcontroller according to claim 19 and wherein the value of N in the bit-reverse instruction is comprised in a third GPR.

22. The microcontroller according to claim 19 and wherein the second GPR of the bit-reverse instruction is the same as the first GPR of the bit-reverse instruction, thereby performing in-place bit-reversal.

23. The microcontroller according to claim 19 and wherein the number of bits in the swap instruction is eight, thereby having the swap instruction swap locations of bytes of a general purpose register.

24. The microcontroller according to claim 19, and wherein the load-filter-store instruction is operative to perform a convolution operation.

25. The microcontroller of claim 19 and wherein at least one of the following is performed in a single cycle:
the concatenate-and-accumulate instruction;
the bit-reverse instruction;
the get-bits instruction;
the put-bits instruction;
the median instruction;
the controller instruction;
the swap instruction;
the load-filter-store instruction;
the clip-N-K instruction; and
the compare-PID instruction.

26. The microcontroller of claim 19 and wherein the micro controller is operative to perform more than one operation in a single cycle, by using more than one microprocessor.

27. The microcontroller of claim 19 and wherein the micro controller is operative to perform more than one operation in a single cycle, by using more than one Arithmetic Logic Unit (ALU).

28. The microcontroller of claim 19 and wherein more than one register, each of the registers comprised of one or more bits, can be dynamically configured into one register comprising a number of bits equal to the total number of bits in the registers.

29. The microcontroller of claim 19 and further comprising a step register, the step register operative to automatically increment a value in a first general purpose register every time a second general purpose register is accessed.
